(19) United States
(12) Patent Application Publication
(10) Pub. No.: US 2026/0183592 A1
(43) Pub. Date: Jul. 2, 2026

(54) Systems and Methods for Generating and Controlling Acoustic Waves for Fire Suppression

(71) Applicant: Incaendium Initiative Corporation, Cleveland, OH (US)

(72) Inventor: Geoffrey Adam BRUDER, Rocky River, OH (US)

(21) Appl. No.: 19/191,367

(22) Filed: Apr. 28, 2025

Related U.S. Application Data
(60) Provisional application No. 63/640,016, filed on Apr. 29, 2024.
(60) Provisional application No. 63/752,209, filed on Jan. 31, 2025.

(51) Int. Cl. A62C 99/00; A62C 37/36

(52) U.S. Cl. CPC A62C 99/00; A62C 37/04

(57) ABSTRACT

Various acoustic fire suppression systems and methods of controlling the same are disclosed. An acoustic fire suppression system includes an acoustic wave generator coupled to an acoustic wave guide having acoustic wave emitters distributed along the wave guide. A command module is used to selectively open one or more of the acoustic wave emitters for emitting acoustic waves into the atmosphere towards a fire at a resonant frequency of the acoustic wave guide. The resonant frequency at which the acoustic waves are emitted from the acoustic wave emitters can be determined by the control module based on a location of a selected acoustic wave emitter among the one or more acoustic wave emitters and the surrounding temperature and/or other ambient conditions.

### RELATED APPLICATIONS

This application claims the benefit of U.S. Provisional Application No. 63/640,016, filed on Apr. 29, 2024 and U.S. Provisional Application No. 63/752,209, filed on Jan. 31, 2025, the disclosures of which are hereby incorporated by reference in their entirety.

### TECHNICAL FIELD

The present invention relates to fire suppression systems and methods, and particularly to an acoustic fire suppression system (sometimes referred to herein as an “acoustic cannon”) along with methods for generating and controlling acoustic waves to suppress fires.

### BACKGROUND

Traditional fire suppression methods have long relied on chemicals such as per- and polyfluoroalkyl substances (PFAS) and clean agents like halon and FM-200 to extinguish fires efficiently. However, growing concerns over the environmental and health impacts of these chemicals have prompted regulatory actions aimed at banning or restricting their use.

The Environmental Protection Agency (EPA) and other regulatory bodies have highlighted the adverse effects of PFAS and clean agents on human health and the environment. PFAS chemicals are persistent in the environment, bioaccumulate in living organisms, and have been linked to various health issues, including cancer and reproductive disorders. Additionally, clean agents contribute to ozone depletion and have high global warming potential.

As a response to these concerns, governments worldwide are implementing bans and regulations to restrict the use of PFAS and clean agents in firefighting applications. These impending bans necessitate the development of alternative fire suppression technologies that are effective, environmentally friendly, and compliant with emerging regulations.

Moreover, traditional fire suppression methods, including water-based systems and chemical agents, often result in collateral damage to property and the environment. Water-based systems can cause extensive water damage, while chemical agents may leave residue and toxic byproducts. Consequently, there is a growing demand for fire suppression solutions that can effectively combat fires without causing harm to the surrounding area.

Additionally, existing fire suppression technologies have operational limitations that cause vulnerabilities and risk, namely with systems having limited suppressant quantity due to volume and weight restrictions. These limitations hinder the operational potential of fire suppression systems.

Therefore, there is a need for improved systems and methods for fire suppression capable of overcoming the foregoing deficiencies in traditional fire suppression methods.

### SUMMARY

The present invention is an acoustic fire suppression system (referred to herein as an “acoustic cannon”) that includes an acoustic wave generator coupled to an acoustic wave guide having at least one acoustic wave emitter. Embodiments of the acoustic fire suppression system leverage the use of acoustic waves for fire suppression, thereby providing effective protection against fires while minimizing environmental impact and collateral damage. As described herein, embodiments of the acoustic fire suppression system can be used for combating fires in various settings including, without limitation, residential, commercial, wildland, and industrial environments, while addressing regulatory concerns associated with traditional firefighting chemicals.

According to one aspect, an acoustic fire suppression system can include an acoustic wave guide, an acoustic wave generator coupled to the acoustic wave guide, and a command module. The command module is configured to perform a number of operations, including selectively opening one or more acoustic wave emitters of the acoustic wave guide for emitting acoustic waves into the atmosphere towards a fire; determining a resonant frequency of the acoustic wave guide based on a location of a selected acoustic wave emitter among the one or more acoustic wave emitters; and controlling the acoustic wave generator to generate the acoustic waves that are emitted through the one or more acoustic wave emitters at the resonant frequency of the acoustic wave guide determined based on the location of the selected acoustic wave emitter. The one or more acoustic wave emitters can be selectively opened based on a proximity of the one or more acoustic wave emitters to a detected fire. The acoustic wave guide can be configured as a duct, a network of interconnected duct segments, or a flexible conduit such as a hose.

In some embodiments, to determine the resonant frequency of the acoustic wave guide that is associated with the selected acoustic wave emitter, the control module can be configured to determine a length of a path through the acoustic wave guide from the acoustic wave generator to the location of the selected acoustic wave emitter; determine a speed of sound under ambient conditions surrounding the acoustic wave guide, the ambient conditions including at least ambient temperature; and determine the resonant frequency of the acoustic wave guide based on the length of the path through the acoustic wave guide to the location of the selected acoustic wave emitter and the speed of sound under the ambient conditions surrounding the acoustic wave guide.

In some embodiments, the acoustic wave guide includes a network of interconnected duct segments. The acoustic wave emitters of the acoustic wave guide can be distributed along the network of interconnected duct segments, such that one or more of the interconnected duct segments define the path to the location of the selected acoustic wave emitter. To determine the length of the path through the acoustic wave guide to the selected acoustic wave emitter, the control module can be configured to determine the length of the path through the one or more interconnected duct segments to the location of the selected acoustic wave emitter.

In some embodiments, the network of interconnected duct segments of the acoustic wave guide can include a first duct segment that extends away from the acoustic wave generator and one or more second duct segments that branch away from the first duct segment. In such embodiments, to determine the length of the path through the acoustic wave guide to the selected acoustic wave emitter, the control module can be configured to determine the length of the path from a proximal end of the first duct segment to the selected acoustic wave emitter located at any of the first duct segment and the one or more second duct segments of the acoustic wave guide.

In some embodiments, the acoustic wave emitters can be spaced apart at or near locations along the acoustic wave guide that correspond to expected locations of atmospheric pressure nodes of a standing wave that forms within the acoustic wave guide in response to the acoustic waves being generated at the resonant frequency of the acoustic wave guide. In some embodiments, the acoustic wave guide is operated as a quarter wavelength acoustic resonator, such as a one quarter (¼) wavelength acoustic resonator, a five quarter (5/4) wavelength acoustic resonator, a nine quarter (9/4) wavelength acoustic resonator, or any multiple of the one quarter (¼) wavelength acoustic resonator. The resonant frequency of the acoustic wave guide for the selected acoustic wave emitter can be a frequency within an inclusive range of 10 Hertz to 80 Hertz.

In some embodiments, the acoustic wave generator can drive a piston to generate the acoustic waves at the resonant frequency of the acoustic wave guide associated with the selected acoustic wave emitter. The control module can adjust an operating frequency of the piston at which the acoustic wave generator drive the piston to match the resonant frequency of the acoustic wave guide in response to changes in the ambient conditions surrounding the acoustic wave guide.

In some embodiments, the acoustic wave generator can drive the piston with a stroke length that emits the acoustic waves from the selectively opened acoustic wave emitters of the acoustic wave guide at a selected intensity to reach a target distance. In some embodiments, at least one additional acoustic wave generator can be operated in combination with the acoustic wave generator to increase the intensity of the acoustic wave propagating from the selectively opened acoustic wave emitters of the acoustic wave guide.

According to another aspect, methods of controlling an acoustic fire suppression system that includes an acoustic wave generator coupled to an acoustic wave guide is disclosed. The method can include selectively opening one or more acoustic wave emitters distributed along the acoustic wave guide for emitting acoustic waves into the atmosphere towards a fire; determining a resonant frequency of the acoustic wave guide based on a location of a selected acoustic wave emitter among the one or more acoustic wave emitters; and controlling the acoustic wave generator to generate the acoustic waves that are emitted through the one or more acoustic wave emitters at the resonant frequency of the acoustic wave guide determined based on the location of the selected acoustic wave emitter. The one or more acoustic wave emitters can be selectively opened among the acoustic wave emitters based on a proximity of the one or more acoustic wave emitters to the fire. The acoustic wave guide can be configured as a duct, a network of interconnected duct segments, or a flexible conduit such as a hose.

In some embodiments, determining the resonant frequency of the acoustic wave guide that is associated with the selected acoustic wave emitter can include determining a length of a path through the acoustic wave guide from the acoustic wave generator to the location of the selected acoustic wave emitter; determining a speed of sound under ambient conditions surrounding the acoustic wave guide, including at least ambient temperature; and determining the resonant frequency of the acoustic wave guide based on the length of the path through the acoustic wave guide to the location of the selected acoustic wave emitter and the speed of sound under the ambient conditions surrounding the acoustic wave guide.

In some embodiments, the acoustic wave guide includes a network of interconnected duct segments. The acoustic wave emitters can be distributed along the network of interconnected duct segments, such that one or more of the interconnected duct segments define the path to the location of the selected acoustic wave emitter. The resonant frequency of the acoustic wave guide can be determined based on a length of the path through the one or more interconnected duct segments to the location of the selected acoustic wave emitter.

In some embodiments, the network of interconnected duct segments of the acoustic wave guide can include a first duct segment that extends away from the acoustic wave generator and one or more second duct segments that branch away from the first duct segment. In such embodiments, the resonant frequency of the acoustic wave guide can be determined based on a length of the path from a proximal end of the first duct segment to the selected acoustic wave emitter located at any of the first duct segment and the one or more second duct segments.

In some embodiments, the acoustic wave emitters can be spaced apart at or near locations along the acoustic wave guide that correspond to expected locations of atmospheric pressure nodes of a standing wave that forms within the acoustic wave guide in response to the acoustic waves being generated at the resonant frequency of the acoustic wave guide.

In some embodiments, the acoustic wave guide is operated as a quarter wavelength acoustic resonator, such as a one quarter (¼) wavelength acoustic resonator, a five quarter (5/4) wavelength acoustic resonator, a nine quarter (9/4) wavelength acoustic resonator, or any multiple of the one quarter (¼) wavelength acoustic resonator. The resonant frequency of the acoustic wave guide for the selected acoustic wave emitter can be a frequency within an inclusive range of 10 Hertz to 80 Hertz.

In some embodiments, the acoustic wave generator can drive a piston to generate the acoustic waves at the resonant frequency of the acoustic wave guide associated with the selected acoustic wave emitter. In such embodiments, the method can further include adjusting an operating frequency of the piston to match the resonant frequency of the acoustic wave guide in response to changes in the ambient conditions surrounding the acoustic wave guide.

In some embodiments, the acoustic wave generator can drive the piston with a stroke length that emits the acoustic waves from the selectively opened acoustic wave emitters of the acoustic wave guide at a selected intensity to reach a target distance. In some embodiments, at least one additional acoustic wave generator can be operated in combination with the acoustic wave generator to increase the intensity of the acoustic wave propagating from the selectively opened acoustic wave emitters of the acoustic wave guide.

According to another aspect, the acoustic fire suppression system can have a nested acoustic wave guide for compactness. In some embodiments, the nested acoustic wave guide can include multiple annular wave guide segments nested coaxially around a cylindrical wave guide segment. The annular wave guide segments and the cylindrical wave guide segment can be interconnected to define a continuous folded path, such that a total length of the continuous folded path is approximately equal to a quarter wavelength of the resonant frequency of the acoustic pressure wave guide. In such embodiments, a cross sectional length of the nested acoustic wave guide is shorter than the total length of the continuous folded path of the acoustic pressure wave guide.

According to another aspect, the acoustic fire suppression system can include an electromechanical linear motion actuator for driving the piston.

### BRIEF DESCRIPTION OF THE DRAWINGS

The foregoing will be apparent from the following more particular description of example embodiments of the invention, as illustrated in the accompanying drawings in which like reference charters refer to the same parts throughout the different views. The drawings are not necessarily to scale, emphasis instead being placed upon illustrating embodiments of the present invention.

FIG. 1A is a schematic diagram of an example embodiment of an acoustic fire suppression system having an acoustic wave guide in the form of a duct.

FIG. 1B is a schematic diagram of an example embodiment of a distributed acoustic fire suppression system having an acoustic wave guide in the form of a network of duct segments.

FIG. 2 is a schematic diagram of another example embodiment of an acoustic fire suppression system having an acoustic wave guide in the form of a hose.

FIGS. 3A-3C are schematic diagrams that illustrate an acoustic wave guide being operated as a quarter wavelength acoustic resonator at different resonant frequencies.

FIG. 4 is a schematic diagram illustrating example components of an acoustic fire suppression system.

FIG. 5 is a flow chart illustrating an example embodiment of a method for controlling the example embodiments of an acoustic fire suppression system.

FIGS. 6A-6E are schematic diagrams of an example embodiment of an electromechanical linear motion actuator that is configured to drive a piston at the proximal end of an acoustic wave guide.

FIGS. 7A-7F are schematic diagrams of an example embodiment of a compact acoustic fire suppression system having a nested acoustic wave guide coupled to an acoustic wave generator.

FIGS. 8A and 8B are schematic diagrams that illustrate example embodiments of acoustic fire suppression systems configured for suppressing fires inside or outside a building.

FIGS. 9A and 9B are schematic diagrams that illustrate example embodiments of acoustic fire suppression systems configured for suppressing fires in a kitchen or other cooking facility.

FIGS. 10A and 10B are schematic diagrams that illustrate example embodiments of acoustic fire suppression systems mounted to any vehicle capable of transporting the acoustic fire suppression system to the location of, or in the vicinity of, a fire.

FIG. 11 is a schematic diagram that illustrate an example embodiment of a compact acoustic fire suppression system mounted to on an aerial wire transport system.

FIG. 12A-12D are schematic diagrams of an example embodiment of an acoustic fire suppression system that includes an acoustic wave generator having more than one piston for increasing the intensity of the acoustic waves emitted from the acoustic wave guide.

FIGS. 13A and 13B are schematic diagrams illustrating an example embodiment of an acoustic fire suppression system including a modular arrangement of multiple acoustic wave generators that are coupled to an acoustic wave combiner having multiple acoustic wave guide inlet segments and a single acoustic wave outlet segment.

FIGS. 14A and 14B are schematic diagrams illustrating an acoustic fire suppression system that includes multiple acoustic wave generators in different layouts arranged in different layouts for increasing the intensity of acoustic waves.

FIG. 15 is an example timing diagram illustrating multiple acoustic fire suppression systems emitting acoustic waves at different times such that the individual acoustic waves converge in phase at a common focus point.

### DETAILED DESCRIPTION

Certain exemplary embodiments will now be described to provide an overall understanding of the principles of the structure, function, and use of the systems, methods and devices disclosed herein. One or more examples of these embodiments are illustrated in the accompanying drawings. Those skilled in the art will understand that the systems, methods, and components specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-named components of the embodiments generally have similar features and/or purposes, unless stated otherwise.

For a fire to burn, at least three elements are required, namely heat, fuel (e.g., wood or other combustible material), and oxygen. An acoustic fire suppression system is disclosed herein that efficiently converts electrical energy to acoustic energy that creates acoustic waves of high and low pressure. The acoustic waves emitted from the system cause air molecules, including oxygen, to move or vibrate. When air molecules that are involved in the chemical reaction of a fire are forced to vibrate faster than flame speed by induced acoustic waves (i.e., the expansion rate of a flame front in a combustion reaction), the combustion reaction cannot be sustained and thus the flames become suppressed (e.g., extinguished or otherwise reduced). This effect can be different than if flame speed is exceeded by unidirectional flow, such as wind, because unidirectional flow is introducing new oxygen to the chemical reaction.

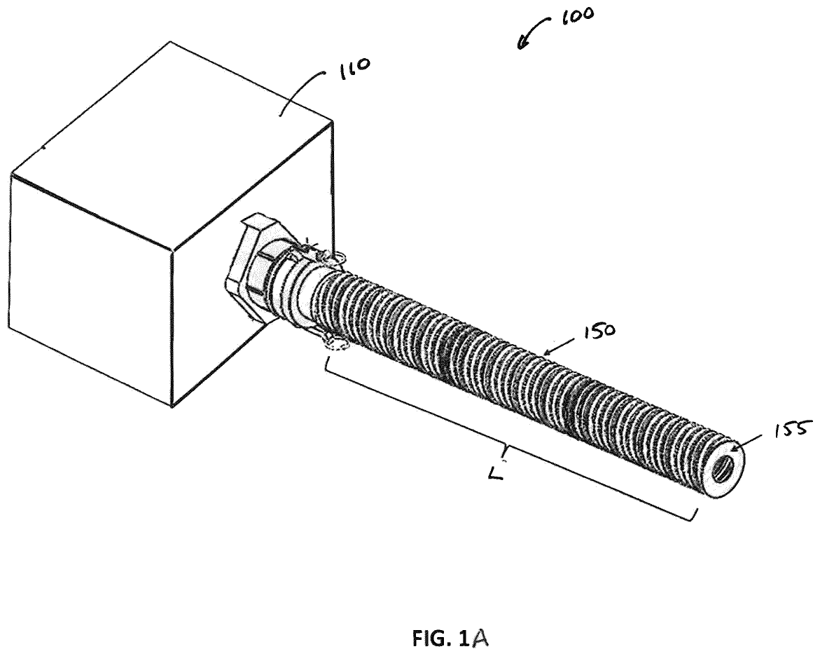

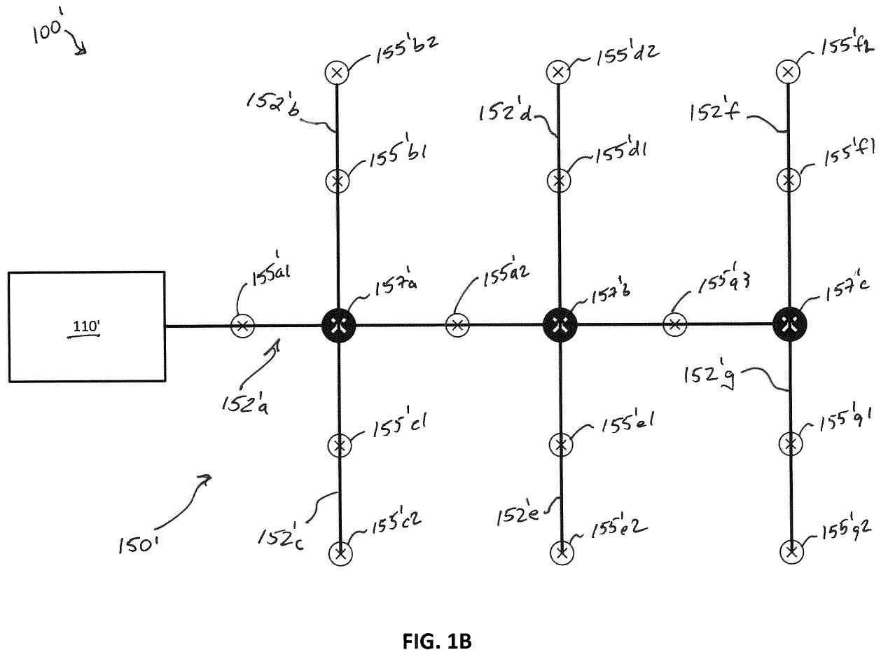

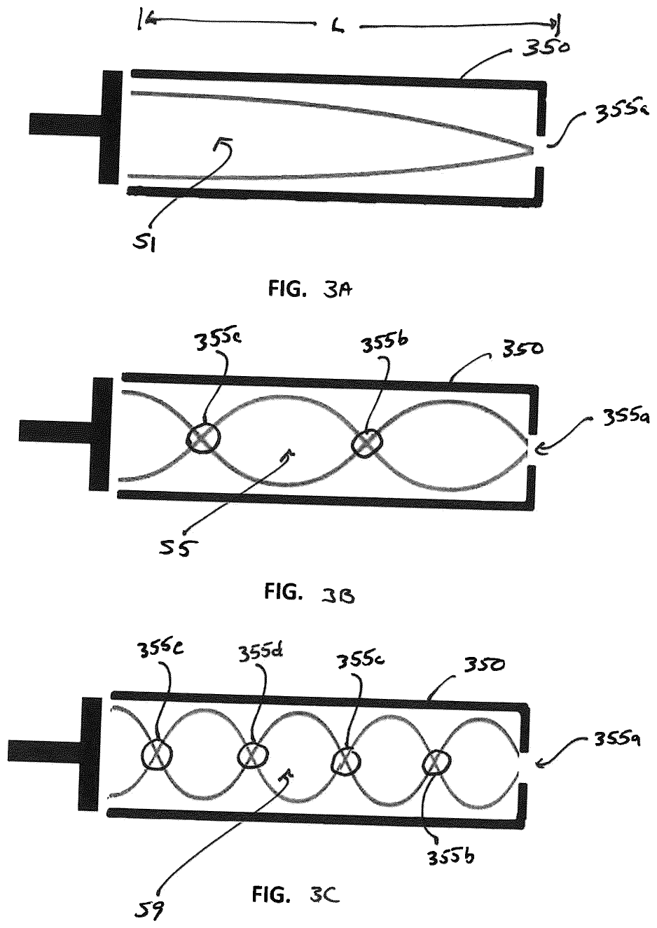

FIG. 1A is a schematic diagram of an example embodiment of an acoustic fire suppression system 100. In the illustrated embodiment, the acoustic fire suppression system 100 includes an acoustic wave generator 110 coupled to an acoustic wave guide 150 in the form of a duct. As shown, the acoustic wave guide 150 defines a single path away from the acoustic wave generator 110 to an acoustic wave emitter 155 located at a distal end of the acoustic wave guide. The acoustic wave guide 150 can be a duct that extends in a linear direction from an outlet of the acoustic wave generator 110. In other embodiments, the acoustic wave guide 150 can be a duct having one or more bends or turns. Although FIG. 1A shows only one acoustic wave emitter 155 at the terminal end of the acoustic wave guide 150, multiple acoustic wave emitters can be positioned at various locations along the length of the wave guide as discussed below in connection with FIGS. 3A-3C. In some embodiments, the duct can be statically placed in a location that is suspected to be a potential location of fire, or the duct can be aimed manually or by robotic or other mechanical means.

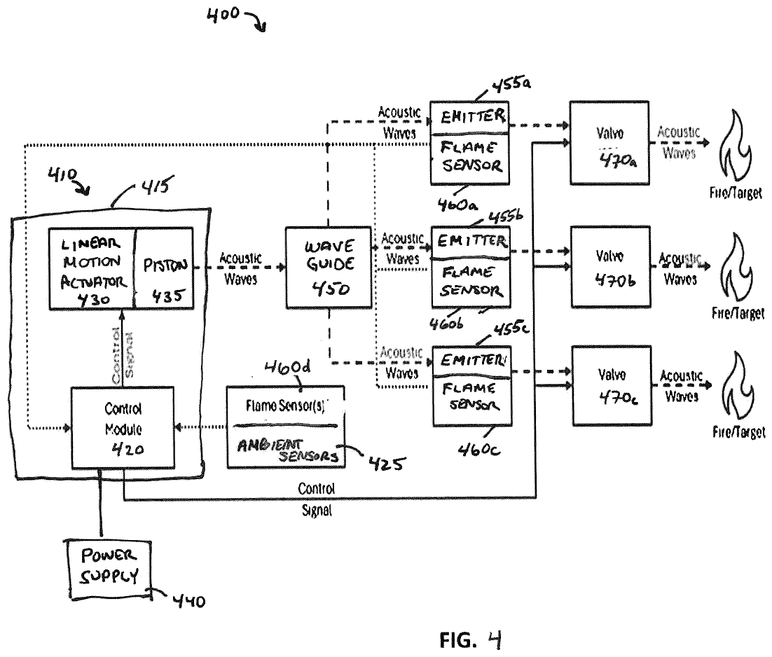

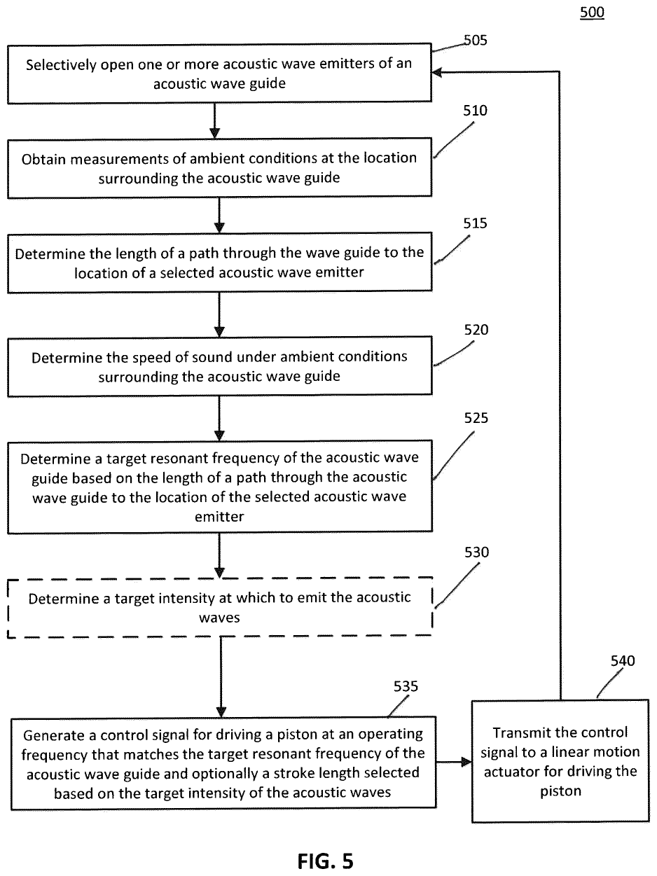

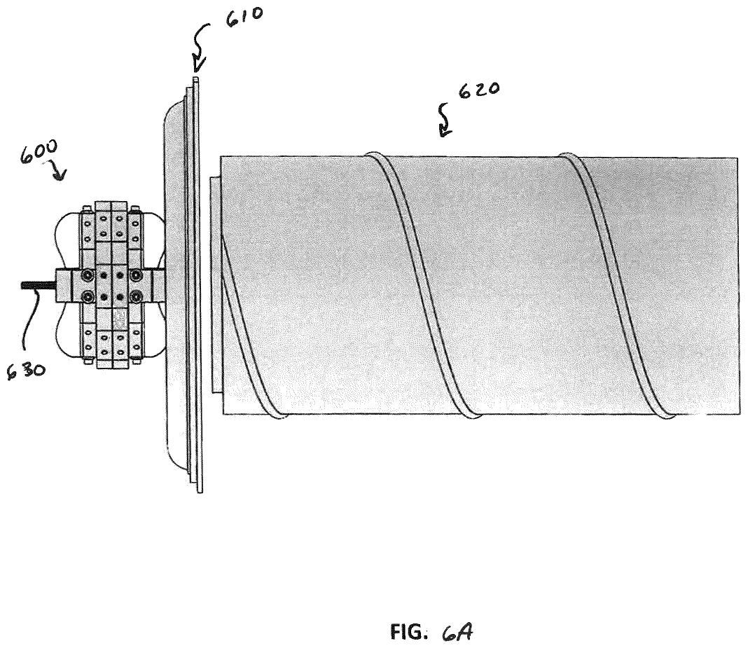

The acoustic wave generator 110 can be substantially the same as, if not identical to, the acoustic wave generator described below in connection with FIG. 4. In particular, the acoustic wave generator 110 causes a volume of air within the acoustic wave guide 150 to fluctuate between compression and expansion. By the ideal gas law, this compression and expansion of the air volume creates a corresponding pressure increase and decrease within the wave guide 150. As the pressure increases and decreases, air particles vibrate within the wave guide 150 such that an acoustic wave is transmitted towards the acoustic wave emitter 155, which in this embodiment is positioned at the distal end of the wave guide. The acoustic wave is then transmitted into ambient air from the acoustic wave emitter 155 in the direction at which the acoustic wave emitter is aimed, e.g., at flames of a fire. Although some air may be released and pulled back through the emitter, the air inside the acoustic wave guide 150 generally remains therein, fluctuating between compression and expansion.

When the acoustic waves reach the fire, the acoustic waves vibrate the air that the flames are using in the chemical reaction. This air vibration, if at sufficient amplitude and appropriate frequency, disrupts the chemical reaction and subdues or arrests the flame. In some embodiments, the acoustic waves that propagate from the acoustic wave emitter 155 of the acoustic wave guide 150 are emitted at low frequencies between 5 Hz and 80 Hz, and preferably between 10 Hz to 25 Hz. Transmission of acoustic waves within these frequency ranges generally cause air molecules to move or vibrate faster than flame speed. When air molecules that are involved in the chemical reaction of a fire are forced to vibrate faster than flame speed by induced acoustic waves (i.e., the expansion rate of a flame front in a combustion reaction), the combustion reaction cannot be sustained such that the flames are subdued or arrested. This effect can be different than if flame speed is exceeded by unidirectional flow, such as wind, because unidirectional flow is introducing new oxygen to the chemical reaction.

The acoustic wave emitter 155 can be an opening that is configured to restrict the flow of the acoustic waves such that a vortex surrounds columnated acoustic waves. In some embodiments, the flow restriction can be an opening having a diameter approximately one half of the diameter of the acoustic wave guide 150. In some embodiments, the acoustic wave emitter(s) can be selectively activated using a valve, such as a butterfly valve. When multiple acoustic emitters are activated, the exiting acoustic waves may overlap as they disperse and combine to form a larger oscillating air volume.

FIG. 1B is a schematic diagram of an example embodiment of a distributed acoustic fire suppression system 100′. The distributed acoustic fire suppression system 100′ includes an acoustic wave generator 110′ coupled to an acoustic wave guide 150′. The acoustic wave generator 110′ can be substantially the same as, if not identical to, the acoustic wave generator described below in connection with FIG. 4. In the illustrated embodiment, the acoustic wave guide 150′ is configured as a network of interconnected duct segments 152′a, 152′b, 152′c, 152′d, 152′e, 152′f, 152′g (collectively or individually 152′) that defines multiple paths away from the acoustic wave generator 110′ to various acoustic wave emitters 155′ₐ, 155′_{b1}, 155′_{b2}, 155′_{c1}, 155′_{c2}, 155′_{d1}, 155′ₐ₂, 155′ₑ₁, 155′ₑ₂, 155′_{f1}, 155′_{f2}, 155′_{g1}, 155′_{g2} (collectively or individually 155′) distributed along the segments 152′. For example, as shown, the network of duct segments 152′ can include a main duct segment 152′a and multiple secondary duct segments 152′b, 152′c, 152′d, 152′e, 152′f, and 152′g that branch away from the main duct segment 152′a.

The acoustic wave emitters 155′ can be located and selectively opened at any of the interconnected duct segments 152′. Each path through the acoustic wave guide 150′ extends through one or more consecutively interconnected duct segments to one or more of the acoustic wave emitters 155′. When multiple acoustic wave emitters are opened, the exiting acoustic waves may overlap as they disperse and combine to form a larger oscillating air volume. Although nine acoustic wave emitters 155′ are shown, any number of acoustic wave emitters can be along the various interconnected duct segments.

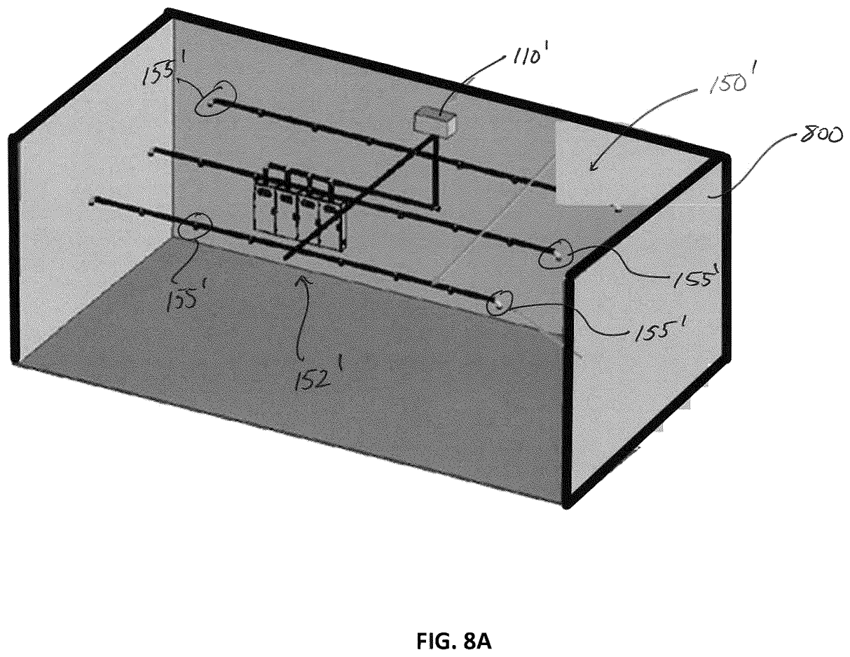

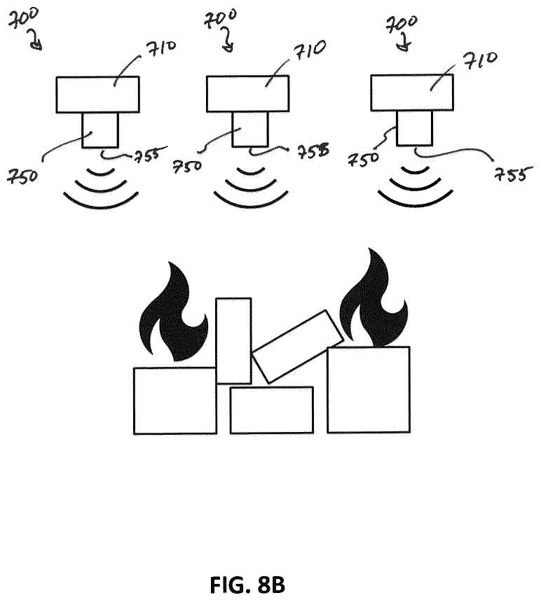

In some embodiments, valves 157′a, 157′b, 157′c (collectively or individually 157′) can be disposed, without limitation, at junctions between two or more adjacent pairs of interconnected duct segments 152′. The valves 157′ can be selectively activated to open a path through one or more of the interconnected duct segments 152′ to one or more of the acoustic wave emitters 155′, while closing paths through the other duct segments. For example, the valves 157′a and 157′b can be activated to open a path that extends from the proximal end of the main duct segment 152′a through the distal end of the secondary duct segment 152′d that includes acoustic wave emitters 155′_{d1}, 155′_{d2}. Although six secondary duct segments 152′ are shown, the number of secondary duct segments can be one or more secondary duct segments. As discussed in connection with FIG. 8A, the acoustic fire suppression system 100′ can be used to suppress fires inside or outside of buildings.

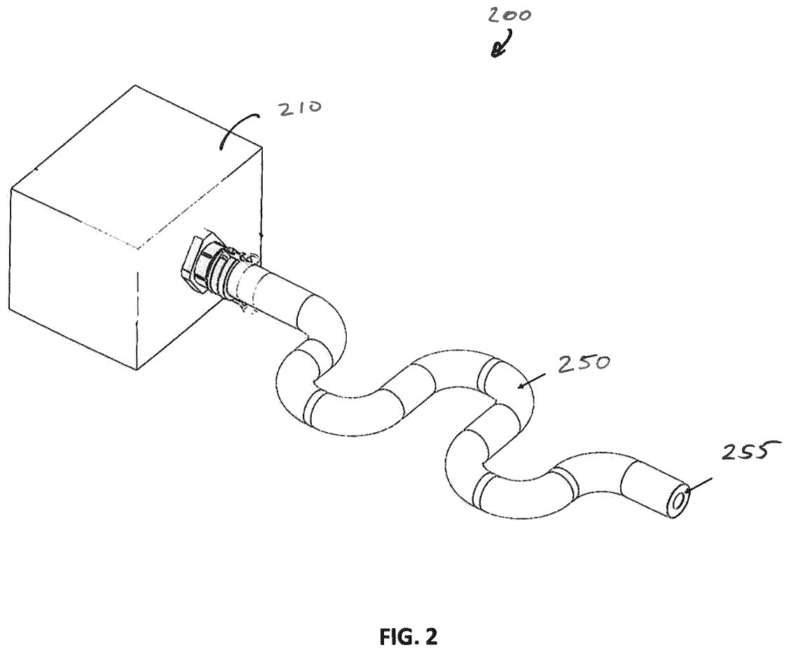

FIG. 2 is a schematic diagram of another example embodiment of an acoustic fire suppression system. In the illustrated embodiment, the acoustic fire suppression system 200 includes an acoustic wave generator 210 coupled to an acoustic wave guide 250 in the form of a hose or other flexible conduit. For example, the hose can be a conventional fire hose with its nozzle replaced with an acoustic wave emitter 255. In some embodiments, the acoustic wave emitter 255 can be a cap defining an opening with a diameter that is less than a diameter of the hose. The hose can be aimed manually or by robotic or other mechanical means. The acoustic wave generator 210 can be substantially the same as, if not identical to, the acoustic wave generator described below in connection with FIG. 4.

To efficiently transmit acoustic waves from one or more acoustic wave emitters to the surrounding air, each of the foregoing acoustic fire suppression systems can be operated as a quarter wavelength acoustic resonator. As a quarter wavelength acoustic resonator, the acoustic wave guide amplifies acoustic waves generated by the acoustic wave generator at a frequency that matches a resonant frequency of the acoustic wave guide. The acoustic wave guide may have more than one resonant frequency. When a frequency of the acoustic waves generated by the acoustic wave generator matches a resonant frequency of the acoustic wave guide, a standing wave is formed within the acoustic wave guide. The resonant frequency f₀ of an acoustic resonator can be calculated by function (1) below:

$${f}_{0} = \frac{nC}{4 L} \qquad ( 1 )$$

where n is the harmonic number, C is the speed of sound, and L is the length of a path through the acoustic wave guide to a selected acoustic wave emitter. For example, if the acoustic wave guide (e.g., 150, 250) defines one path, the length L can be equal to the length of the entire path from the proximal end (i.e., the end coupled to the acoustic wave generator) to the distal end of the acoustic wave guide. Alternatively, the length L can be equal to the length of the path from the proximal end of the acoustic wave guide to the location of one of the selected acoustic wave emitter(s) to open, which may be located either at the distal end of the wave guide or at an intermediate position between the proximal end and the distal end of the wave guide. Alternatively, if the acoustic wave guide is configured as a network of interconnected duct segments (e.g., 152′ of FIG. 1B) that defines many paths, the length L can be equal to the length of one of the many paths defined by the acoustic wave guide that extends from the proximal end of the acoustic wave guide through one or more interconnected duct segments to the location of one of the selected acoustic wave emitter(s) to open.

FIGS. 3A-3C are schematic diagrams that illustrate an acoustic wave guide 350 being operated as a quarter wavelength acoustic resonator at different resonant frequencies. The acoustic wave guide 350 can be configured as a fixed length duct as described above in connection with FIG. 1A, one or more consecutively interconnected segments of a network of duct segments that defines one of many paths as described in connection with FIG. 1B, or a fixed length hose as described above in connection with FIG. 2. The acoustic wave generator 310 can be substantially the same, if not identical, to the acoustic wave generator described in connection with FIG. 4.

Referring to FIG. 3A, when a frequency of the acoustic waves generated by the acoustic wave generator 310 matches a resonant frequency of the acoustic wave guide 350 at the first harmonic (or fundamental frequency), a standing wave s1 forms within the acoustic wave guide that extends one quarter (¼) of the wavelength of the resonant frequency. Referring to FIG. 3B, when a frequency of the acoustic waves generated by the acoustic wave generator 310 matches a resonant frequency of the acoustic wave guide 350 at the fifth harmonic, a standing wave s5 forms within the acoustic wave guide that extends five quarter (5/4) wavelengths of the resonant frequency. Referring to FIG. 3C, when a frequency of the acoustic waves generated by the acoustic wave generator 310 matches a resonant frequency of the acoustic wave guide 350 at the ninth harmonic, a standing wave s9 forms within the acoustic wave guide that extends nine quarter (9/4) wavelengths of the resonant frequency.

The standing waves s1, s5, and s5 that form within the acoustic wave guide 350 can include one or more atmospheric pressure nodes. The atmospheric pressure nodes can be present within the acoustic wave guide 350 at a spacing equal to one quarter (¼) of wavelength of the frequency at which the wave guide is resonating. The pressure at each atmospheric pressure nodes is generally equal to the atmospheric pressure surrounding the acoustic wave guide. Furthermore, maximum air displacement occurs at each atmospheric pressure node.

Accordingly, in some embodiments, for maximum intensity (or maximum sound pressure level) of the emitted acoustic waves, one or more emitters 355a, 355b, 355c, 355d, 355e, etc. (collectively or individually 355) can be located along the acoustic wave guide 350 at or near (i.e., within +/−5%) the location of any of the atmospheric pressure nodes of a respective standing wave. By locating an emitter 355 at or near an expected location of an atmospheric pressure node, acoustic waves can be transmitted to the environment with high efficiency, i.e., up to 85% of the electrical power input is converted to acoustic power output.

As discussed above, the resonant frequency f₀ of a quarter wavelength resonator, and thus the frequency of the acoustic waves emitted therefrom depends on the length of a path through the acoustic wave guide to an acoustic wave emitter and the speed of sound C. Thus, the length of the acoustic wave guide 350 from its proximal end to the acoustic wave emitter at the distal end of the wave guide is predetermined such that a target resonant frequency f₀ of the acoustic wave guide at standard temperature and pressure (e.g., 20° C., 101.325 kPa) falls within the range of frequencies sufficient for fire suppression (e.g., 10 Hz to 80 Hz). For example, at standard room temperature and pressure (e.g., 20° C., 101.325 kPa), the wavelength of an acoustic wave having a target resonant frequency f₀ equal to 20 Hz in air is about 56 feet (17.07 meters). Thus, the length of a one quarter (¼) resonator is about 14 feet (4.27 meters).

As discussed above in connection with FIG. 1B, in some embodiments, the acoustic wave guide 350 can be a network of duct segments (e.g., 152′). For example, the network of duct segments can include a main duct segment and one or more secondary duct segments that branch away from the main duct segment, thereby defining multiple paths away from the acoustic wave generator of differing lengths to acoustic wave emitters distributed throughout the segments. Accordingly, the target resonant frequency f₀ at which acoustic wave can be efficiently emitted through a selected acoustic wave emitter 355 can be determined based at least in part on the speed of sound in air under current ambient conditions and the length of a fixed length path through one or more consecutively connected duct segments to the selected acoustic wave emitter.

FIG. 4 is a schematic diagram illustrating example components of an acoustic fire suppression system 400. As shown, the acoustic generator 410 includes a control module 420 and a linear motion actuator 430 coupled to a piston 435. The foregoing components can be contained in a housing 415. However, in some embodiments, the control module 420 can be remotely located for manual operation by an external user, such that the control module communicates with the linear motion actuator 430 over a wired or wireless communication link. In some embodiments, the housing 415 can be a vented housing or a closed resonant volume designed using the Thiele-Small parameters to assist operational resonance at the target frequency of the piston 435.

The power supply 440 can provide power to the various components of the acoustic wave generator 110. In some embodiments, the power supply 440 can be a battery, an external power source, or both. In some embodiments, the ambient sensors 435 can be affixed along a length of the acoustic wave guide 150 or otherwise external to the acoustic fire suppression system 100. In some embodiments, the ambient sensors 435 can be located at or near the location of one or more of the acoustic wave emitter(s) 455a, 455b, 455c (collectively or individually 455).

The control module 420 can be implemented as any of a hardware-based processor, a controller, a printed circuit board (PCB), programmable logic controller (PLC), application specific integrated circuit (ASIC), field programmable gate array (FPGA), custom designed semiconductor logic, combination of passive electrical elements, or any other computing device.

The control module 420 can control a number of operations of the acoustic fire suppression system 400, including control of the linear motion actuator 430. As shown in FIG. 4, the control module 420 can transmit a control signal to the linear motion actuator 430 that causes the actuator to drive the piston 435 at a target operating frequency and a target stroke length. When the target operating frequency of the piston matches the resonant frequency of the acoustic wave guide 450, the transmission and reflection of acoustic waves within the wave guide 450 forms a standing wave therein for efficient transmission of acoustic waves into the environment via one or more acoustic wave emitters 455a, 455b, 455c (collectively or individually 455). The target stroke length can depend on an approximate distance of the fire away from an emitter 455. Although FIG. 4 shows three acoustic wave emitters 455, the acoustic wave guide 450 can have one, two, three or more acoustic wave emitters through which acoustic waves can be transmitted.

In some embodiments, in an automated mode, the control module 430 can transmit the control signal to the linear motion actuator 430 in response to receiving a flame detection signal from one or more flame sensors 460a, 460b, 460c, 460d (individually or collectively 460). The flame sensors 460 can be used to detect flames, heat, smoke, or a chemical signature of a developing fire. The flame sensors 460 can be co-located with respective acoustic wave emitters 455 on the acoustic wave guide 450 (e.g., flame sensors 460a, 460b, 460c). Additionally, or alternatively, one or more flame sensors 460 can be generally located within a space or area near or proximate to a respective acoustic wave emitter 455. Examples of flame sensors 460 can include, without limitation, ultraviolet (UV) flame sensors, infrared (IR) flame sensors, UV/IR flame sensors, multi-spectrum IR flame sensors, IR3 flame sensors, chemical sensors, and visual sensors (e.g., cameras).

Alternatively, or additionally, in a manual mode, the control module 420 can transmit the control signal to the linear motion actuator 430 in response to receiving a manual command input from an external user via an input/output device (not shown). Such manual input commands can be commands that direct the control module 420 to specify a target frequency and intensity or sound pressure level of the acoustic waves to be emitted from the acoustic fire suppression system 400. In some embodiments, the manual input command can be a selection indicating which of the acoustic wave emitters to open. In such embodiments, the control module 420 can determine the parameters (e.g., operating frequency and/or stroke length) at which to drive the piston such that the acoustic waves are emitted from the user-selected acoustic wave emitter(s) at an appropriate frequency and intensity.

In some embodiments, each of the acoustic wave emitters 455a, 455b, 455c can be configured as, or other coupled to, a respective valve 470a, 470b, 470c (collectively or individually 470), such as a butterfly valve. Although the valves 470 are shown located after the acoustic wave emitters 455, the valves can be located before the emitters. Thus, the control module 420 can also be configured to transmit a valve control signal (e.g., a voltage) to selectively open one or more of the valves (e.g., 470a, 470b, and/or 470c) in response to receiving a flame detection signal. For example, upon receiving the flame detection signal, the control module 420 can determine which flame sensor (e.g., 460a, 460b, 460c, and/or 460d) sent the signal and then open one or more of the valves (e.g., 470a, 470b, and/or 470c) associated with the determined flame sensor 460 at the location of the active or potential flame. Alternatively, or additionally, the control module 420 can transmit the valve control signal to selectively open one or more of the valves (e.g., 470a, 470b, and/or 470c) in response to receiving a manual command input from an external user via an input/output device (not shown). Once a valve is open, acoustic waves generated by the linear motion actuator 430 can propagate from a respective acoustic wave emitter 455 into the surrounding environment.

As discussed above, the linear motion actuator 430 drives the piston 435 at a target operating frequency of the acoustic wave guide 420 that matches a resonant frequency of the acoustic wave guide 450, forming a quarter wavelength standing wave therein for efficient transmission of acoustic waves into the environment via one or more acoustic wave emitters 455. However, a resonant frequency of an acoustic resonator is a function of the speed of sound; and the speed of sound varies with various ambient conditions, including temperature, pressure, humidity and/or other environmental conditions. For example, the speed of sound generally increases in response to an increase in ambient temperature, resulting in an increase in wavelength of a particular frequency.

To account for changes in ambient conditions, the control module 420 can be configured to adjust the operating frequency at which the piston 435 is driven by the linear motion actuator 430 to maintain a quarter wavelength standing wave in the acoustic wave guide 150 in response to measurements taken by ambient sensors 425 of the surrounding environment. Examples of ambient sensors 425 can include, without limitation, ambient temperature sensors, ambient pressure sensors, and relative humidity sensors. The ambient sensors 425 can be affixed on or within the housing 415 of the acoustic wave generator 410, along the length of the acoustic wave guide 450, and/or co-located with each of the acoustic wave emitters 455. The ambient sensors can be configured to send measurement data to the control module 420 in real time or periodically (e.g., once every second).

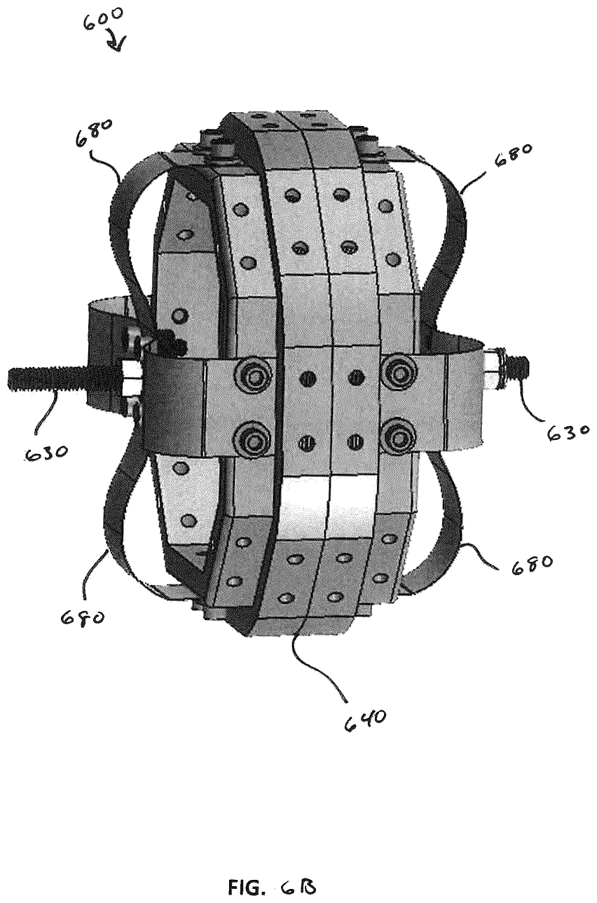

FIG. 5 is a flow chart illustrating an example embodiment of a method 500 for controlling example embodiments of an acoustic fire suppression system. In some embodiments, the method 500 can be performed by a computing device (e.g., control module 420) capable of controlling any of the acoustic fire suppression systems disclosed herein.

At block 505, the control module (e.g., 420) can selectively open one or more acoustic wave emitters (e.g., 455) of the acoustic wave guide (e.g., 450) for emitting acoustic waves into the atmosphere towards a fire. As discussed above in connection with FIG. 4, the control module (e.g., 420) can selectively open at least one of the acoustic wave emitters by sending a control signal to open a respective valve closest to the fire (e.g., in response to receiving a flame detection signal or in response to receiving a manual command).

At block 510, the control module (e.g., 420) can obtain measurements of ambient conditions surrounding the acoustic wave guide (e.g., 450). In some embodiments, the control module (e.g., 420) can obtain measurements of ambient conditions surrounding the acoustic wave guide at the location of at least one of the open acoustic wave emitter(s). Examples of such ambient conditions can include, without limitation, ambient temperature, atmospheric pressure, relative humidity, or any combination thereof. The control module (e.g., 420) can receive the measurements of the ambient environmental conditions from one or more ambient sensors (e.g., 425) in real-time or periodically (e.g., once every second).

At block 515, the control module (e.g., 420) can determine the length L of a path through the waveguide to the location of a selected acoustic wave emitter that is opened at block 505. Where the control module opens more than one acoustic wave emitter at block 505, the control module (e.g., 420) can determine the length L of a path through the waveguide to the location of one of the acoustic wave emitters that are selectively opened at block 505. For example, in some embodiments, the selected acoustic wave emitter from amongst multiple acoustic wave emitters can be the acoustic wave emitter located the furthest away from the acoustic wave generator. In other embodiments, the selected acoustic wave emitter from amongst multiple acoustic wave emitters can be the acoustic wave emitter located the closest to the acoustic wave generator.

In some embodiments, where the acoustic wave guide (e.g., 150, 250, 750) defines only one path, the length L can be the same as the length of the entire path from the proximal end (i.e., the end coupled to the acoustic wave generator) to the distal end of the acoustic wave guide. Alternatively, the length L can be equal to the length of the path from the proximal end of the acoustic wave guide to the location of the selected acoustic wave emitter, which may be located either at the distal end of the wave guide or at an intermediate position between the proximal end and the distal end of the wave guide. In other embodiments, where the acoustic wave guide is configured as a network of interconnected duct segments (e.g., 152′) that defines many paths, the length L can be equal to the length of one of the many paths defined by the acoustic wave guide that extends from the proximal end of the acoustic wave guide through one or more interconnected duct segments to the location of the selected acoustic wave emitter.

At block 520, the control module (e.g., 420) can determine the speed of sound in air C as a function of the measurements of the ambient conditions obtained at block 510. In some embodiments, the speed of sound C can be calculated or otherwise approximated using any known formula as a function of at least ambient temperature and optionally atmospheric pressure, relative humidity, or both. The speed of sound C generally increases in response to an increase in ambient air temperature.

At block 525, the control module (e.g., 420) can determine a target resonant frequency f₀ of the acoustic wave guide (e.g., 450) based on (i) the length L of the path through the acoustic wave guide to the location of the selected acoustic wave emitter as determined in block 515 and (ii) the speed of sound C under current ambient conditions as determined at block 520. In some embodiments, the resonant frequency f₀ of the acoustic wave guide (e.g., 450) can be calculated by function below:

$${f}_{0} = \frac{nC}{4 L}$$

where n is the harmonic number, C is the speed of sound in air, and L is the length of the path through the acoustic wave guide to the location of the selected acoustic wave emitter. The harmonic number n is equal to one (1) where the acoustic wave guide (e.g., 450) is operated as one quarter (¼) wavelength acoustic resonator (e.g., FIG. 3A); the harmonic number n is equal to five (5) where the acoustic wave guide (e.g., 450) is operated as five quarter (5/4) wavelength acoustic resonator (e.g., FIG. 3B); the harmonic number n is equal to nine (9) where the acoustic wave guide (e.g., 450) is operated as nine quarter (9/4) wavelength acoustic resonator (e.g., FIG. 3C); and so on. As discussed above, the target resonant frequency f₀ of the acoustic wave guide determined by the control module (e.g., 420) preferably falls within a range of low frequencies sufficient for fire suppression (e.g., 5 Hz to 80 Hz) regardless of changes in ambient conditions surrounding the acoustic wave guide (e.g., 420).

At optional block 530, the control module (e.g., 420) can determine a target intensity (or sound pressure level) at which to emit the acoustic waves from an acoustic wave emitter (e.g., 455) of the acoustic wave guide (e.g., 450).

In some embodiments, the target intensity at which to emit the acoustic waves can be determined based on an approximate distance of a fire detected by a flame sensor (e.g., 460) away from an acoustic wave emitter (e.g., 455). The approximate distance can be a fixed distance that is known in advance. The approximate distance can also be determined in real-time by a suitable distance sensor, such as but not limited to a light detection and ranging (LIDAR) sensor, infrared proximity sensor, and/or an ultrasonic range sensor.

Once the approximate distance of the fire is determined, the control module (e.g., 420) can select the target intensity of the acoustic waves from a table or other data structure (not shown) of individual sound pressure levels indexed according to respective distance ranges. For example, acoustic waves emitted at an intensity of at least 100 decibels (dB) can suppress a fire within one (1) meter away from an acoustic wave emitter. Acoustic waves emitted at a sound pressure level of at least 130 dB can suppress a fire within eight (8) meters away. Acoustic waves emitted at a sound pressure level of at least 140 dB can suppress a fire within fifty (50) meters away. Acoustic waves emitted at a sound pressure level of at least 165 dB can suppress a fire within one thousand (1000) meters away.

Additionally or alternatively, the intensity at which to emit the acoustic waves can be specified in a manual input command received by the control module (e.g., 420) from an external user via an input/output device (not shown). In some embodiments, the intensity at which to emit the acoustic waves is a maximum or otherwise predetermined intensity.

At block 535, the control module (e.g., 420) can generate a control signal for transmission to the linear motion actuator (e.g., 430) for driving a piston (e.g., 435) that is coupled to a proximal end of the acoustic wave guide (e.g., 450). In some embodiments, the control signal can be a time-varying control signal having a frequency for driving the piston (e.g., 435) at an operating frequency that matches the resonant frequency of the acoustic wave guide (e.g., 430) determined in block 510. The time-varying control signal can also have a peak amplitude for driving the piston (e.g., 435) to have a stroke length selected based on the target intensity or sound pressure level determined at block 525. For example, longer piston stroke lengths can compress and expand larger volumes of air within the acoustic wave guide, thereby producing acoustic waves having higher intensity or sound pressure levels that can suppress fires at greater distances. In some embodiments, the control module (e.g., 420) can select the peak amplitude of the time-varying control from a table or other data structure (not shown) that provides a set of peak amplitude values indexed according to respective intensity or sound pressure levels.

In some embodiments, the time-varying control signal can have a sinusoidal or approximately sinusoidal shape. In some embodiments, the sinusoidal-shaped control signal can be implemented as an AC voltage signal. The AC voltage signal can be generated from an AC voltage provided by an external power source or other power supply (e.g., 440). Alternatively, the AC voltage signal can be a pulse width modulated (PWM) signal generated from a DC voltage provided by a battery or other power supply (e.g., 440).

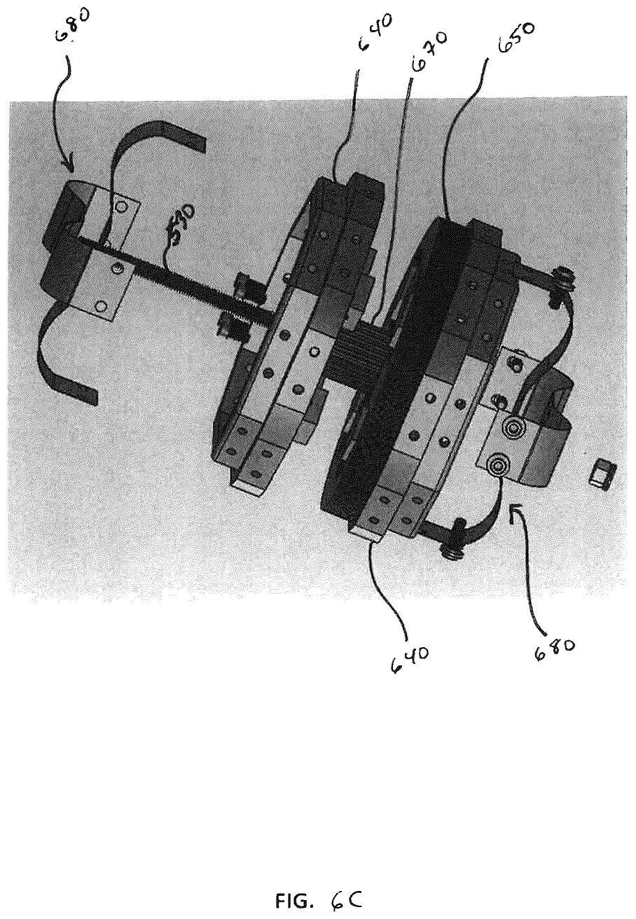

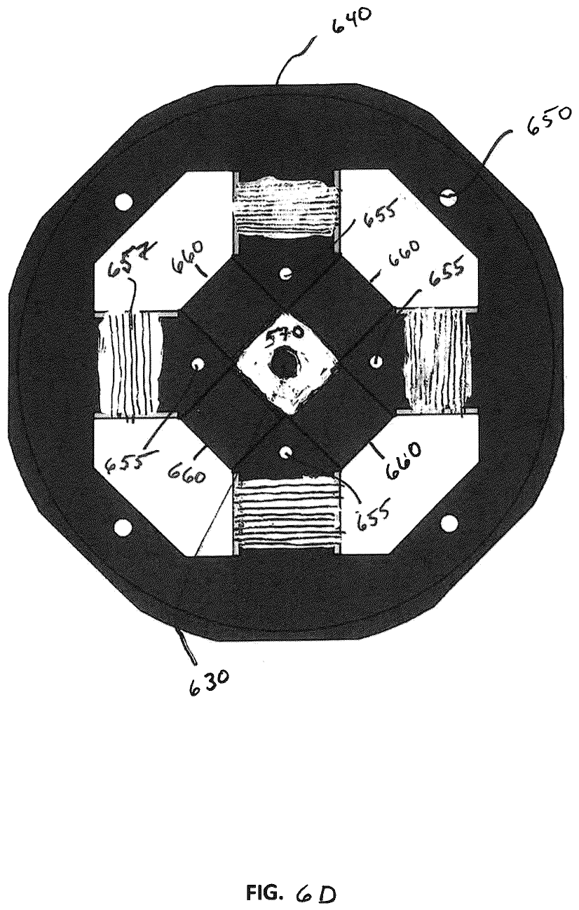

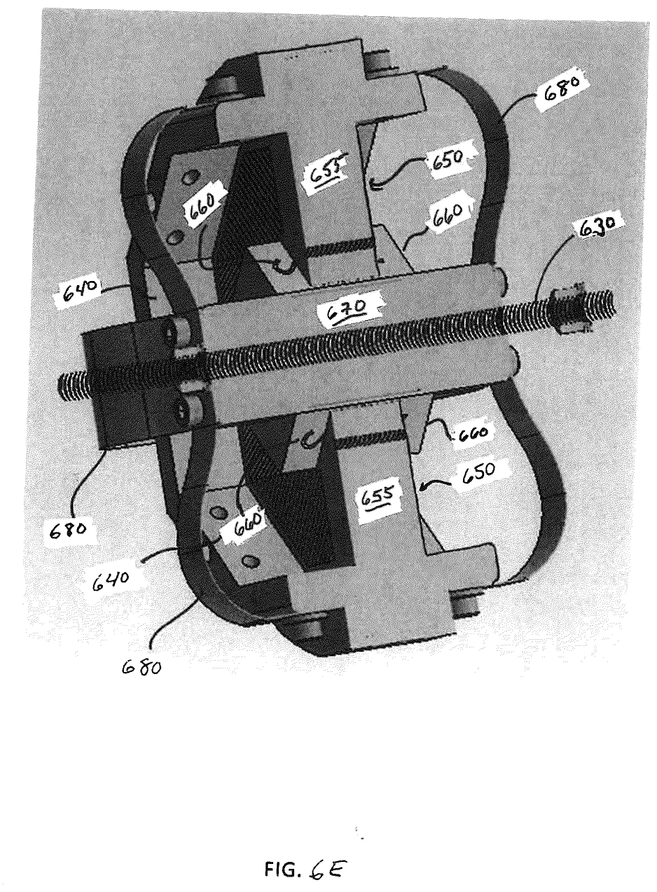

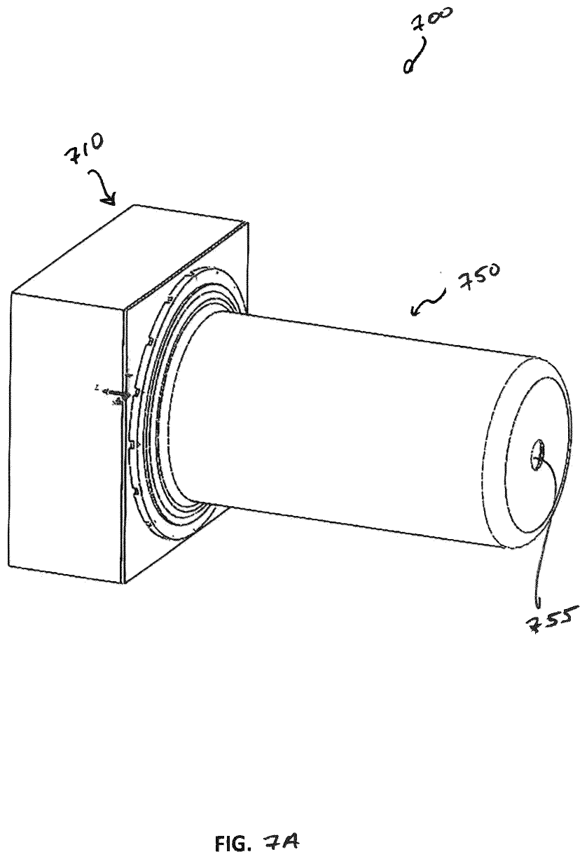

As discussed below in connection with FIGS. 6A-6E, the linear motion actuator can be configured as an electromechanical device having magnet-and-coil type structure. When alternating current flows through the wire coils (e.g., 657) of the electromechanical linear motion actuator (e.g., 600), the wire coils act as an inductor, causing the current in the wire coils to lag an applied voltage of the time-varying control signal. The impedance introduced by the wire coils can cause the current and voltage of the motor power to oscillate out-of-phase with one another, effectively lowering the power factor of the motor and reducing efficiency. Thus, in preferred embodiments, the control module (e.g., 420) at block 535 may be configured to shift a phase of the time-varying control signal (e.g., AC voltage signal) to counter the impedance introduced by the wire coils. In this way, the phase shift of the AC voltage control signal can cause the current and voltage of the electrical power within the coils to be in phase, in a technique commonly called “power factor correction”. In some embodiments, the phase component can be introduced by filtering the AC voltage signal through logic that represents “synthetic capacitor.”

At block 540, the control module (e.g., 420) transmits the control signal generated at block 530 to the linear motion actuator (e.g., 430) for driving the piston (e.g., 435) of the acoustic wave generator (e.g., 410). In response, the piston (e.g., 435) oscillates back-and-forth at an operating frequency that matches the resonant frequency of the acoustic wave guide, such that a quarter wavelength standing wave forms within the acoustic wave guide (e.g., 430). Furthermore, the piston (e.g., 435) oscillates back-and-forth with a stroke length that causes acoustic waves to be emitted from the wave guide at the target intensity determined in block 520 for reaching and suppressing the fire.

In some embodiments, the control module (e.g., 420) can be configured to repeat the steps described in blocks 505 to 540 periodically or continuously in real-time to adjust the control signal for driving the piston (e.g., 435) such that a quarter wavelength standing wave is maintained within the acoustic wave guide (e.g., 430) regardless of changes in ambient conditions surrounding the acoustic wave guide and/or changes in the acoustic wave emitters that are selectively opened for emission of the acoustic waves to suppress a fire.

As indicated above, the linear motion actuator (e.g., 430) can be configured as an electromechanical device having magnet-and-coil type structure. FIGS. 6A-6E are schematic diagrams of an example embodiment of an electromechanical linear motion actuator 600 that is configured to drive a piston 610 at the proximal end of an acoustic wave guide 620.

FIG. 6A is a schematic diagram illustrate a side plan view of the electromechanical linear motion actuator 600 driving a piston 610 at a proximal end of an acoustic wave guide 620. FIG. 6B is schematic diagram illustrating a perspective view of the electromechanical linear motion actuator 600. FIG. 6C is schematic diagram illustrating an exploded perspective view of the components of the electromechanical linear motion actuator 600. FIG. 6D is schematic diagram illustrating a cross-sectional plan view of the electromechanical linear motion actuator 600. FIG. 6E is schematic diagram illustrating a cross-sectional perspective view of the electromechanical linear motion actuator 600.

As shown in FIG. 6A, the electromechanical linear motion actuator 600 includes a piston rod 630 having a distal end that is fixedly attached to the center of the piston 610. The linear motion actuator 600 causes the piston rod 630 to oscillate back-and-forth, thereby driving the back-and-forth motion of the piston 610, such that acoustic waves are generated within the acoustic wave guide 620.

Referring to FIGS. 6B-6E, the electromechanical linear motion actuator 600 further includes a frame 640, a stator 650, magnets 660, a magnet retainer 670, and flexures 680. The frame 640 can be an annular structure to which the other foregoing components are attached. The stator 650 is an annular metallic structure mounted coaxially to an inner surface of the frame 640. The stator 650 includes spokes 655 that extend from an outer perimeter radially towards the center of the stator. Wire coils 657 are wrapped around the spokes 655.

When the control module (e.g., 420 of FIG. 4) transmits a time-varying control signal in the form of an AC voltage signal through the wire coils 655, magnetic flux flows through the stator 650. The magnetic flux interacts with the magnets 660, which are attached to the outer surface of the magnet retainer 670. The magnet retainer 670 can be a rectangular cuboid structure or block that extends through an opening defined between the radial spokes 655 of the stator 650. The piston rod 630 is fixed along a central longitudinal axis of the magnet retainer 670.

The magnet retainer 670 is moveably coupled to the frame 640 by the flexures 680. As shown in FIG. 6E, the flexures 680 can connect each end of the magnet retainer 670 to the frame 640. Although the flexures 680 are shown as linear springs having a flat rectangular shape, the flexures can be configured having other shapes or spring types.

In response to the interaction between the magnets 660 and the magnetic flux flowing through the stator 650, the magnet retainer 670 and the piston rod 630 linearly oscillate back-and-forth at the operating frequency of the AC voltage signal applied by the control module (e.g., 420 of FIG. 4). The linear oscillation of the piston rod 630, in turn, produces an approximately sinusoidal linear displacement of the piston 610. The magnitude of linear displacement of the piston 610, referred to herein as the stroke length, is controlled by the amplitude of the AC voltage signal applied by the control module (e.g., 420 of FIG. 4).

When the electromechanical linear motion actuator 600 moves the piston 610 reciprocally (i.e., back and forth) at a resonant frequency of the acoustic wave guide 620, the air within the acoustic wave guide 620 fluctuates between compression and expansion. This compression and expansion of air forms a quarter wavelength standing wave (e.g., FIGS. 3A-3C) within the acoustic wave guide 620. By forming a standing wave within the interior volume of the acoustic wave guide, acoustic waves propagate from an acoustic wave emitter of the acoustic wave guide at a frequency that matches the resonant frequency of the acoustic wave guide. Although some air may be released and pulled back in at an emitter, the air inside the acoustic wave guide 620 generally remains therein, fluctuating between compression and expansion. The acoustic wave guide 620 is generally a sealed volume, other than the acoustic wave emitter(s).

For certain applications, it may be impractical for the length of the acoustic wave guide to be equal to a quarter wavelength of the acoustic waves to be transmitted. For example, at standard room temperature and pressure (e.g., 20° C., 101.325 kPa), the wavelength of an acoustic wave having a target resonant frequency f₀ equal to 20 Hz in air is about 56 feet (17.07 meters). Thus, the length of a one quarter (¼) resonator is about 14 feet (4.27 meters). Accordingly, in some embodiments, it may be desirable to configure the acoustic wave guide to have the length of a quarter wavelength resonator within a compact structure having a shorter cross-sectional length.

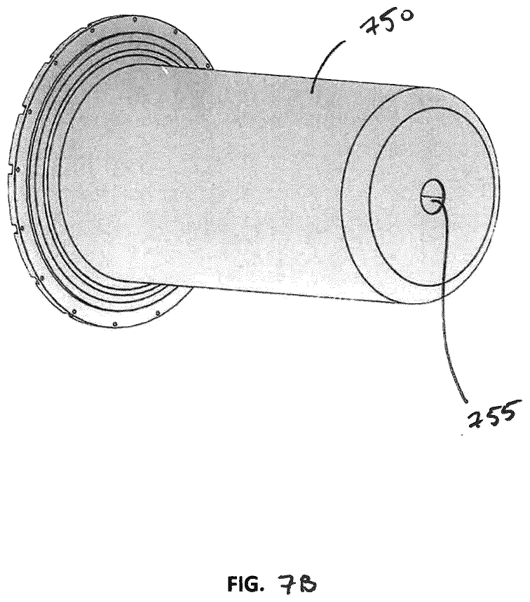

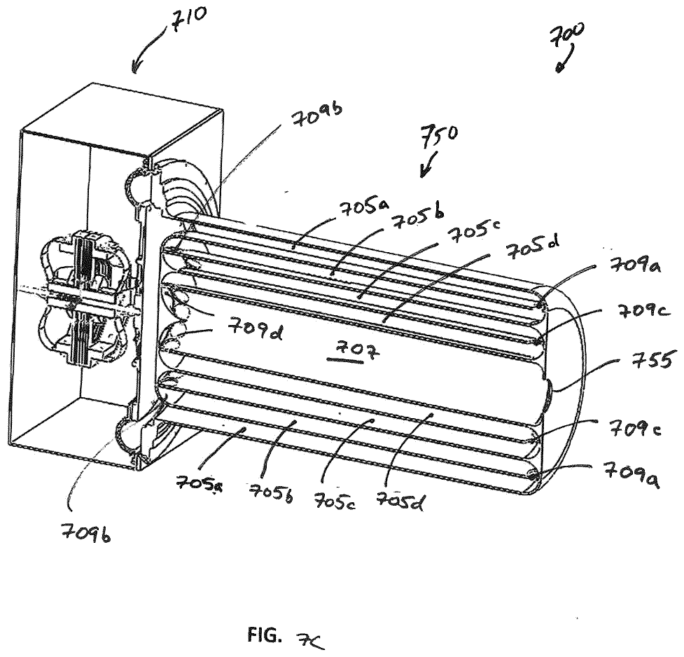

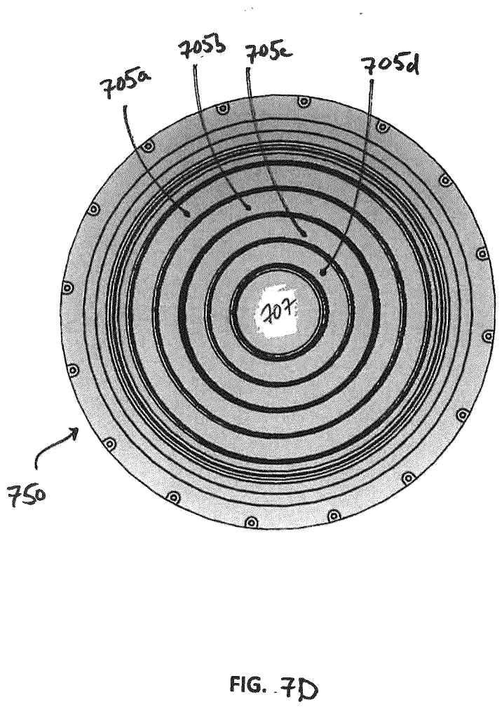

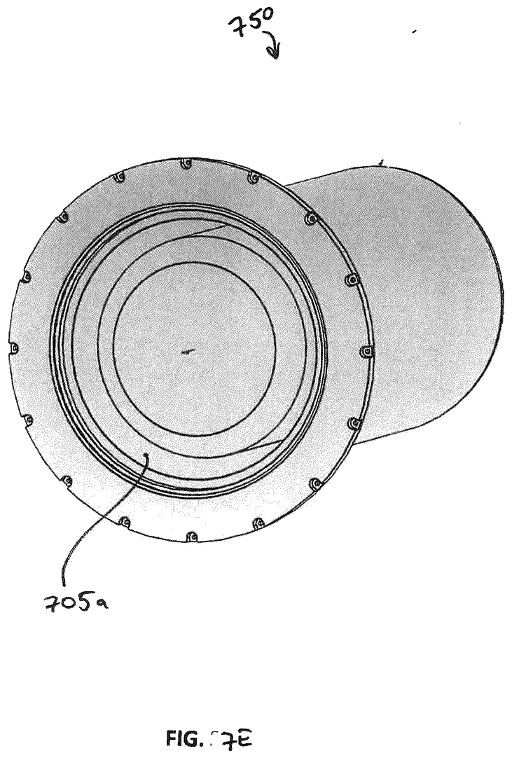

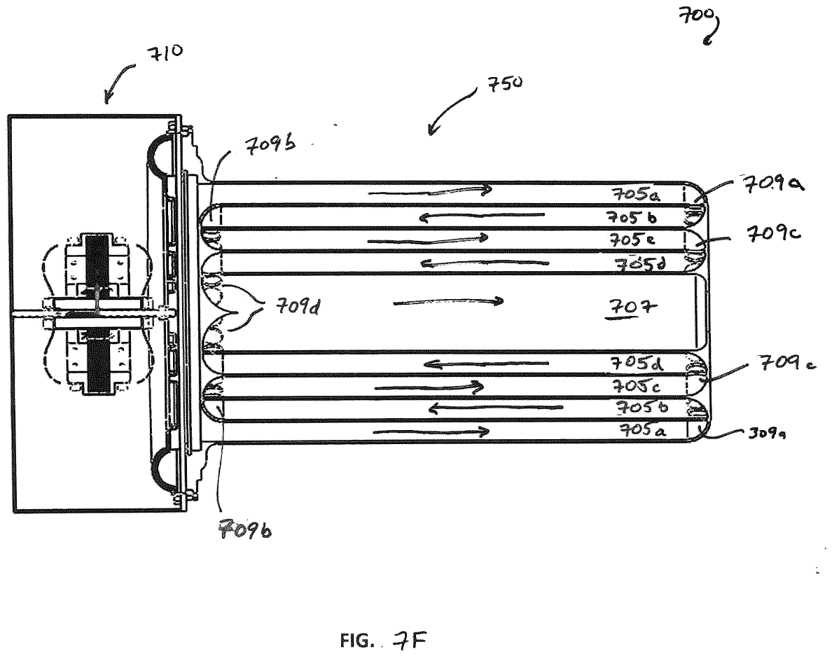

FIGS. 7A-7F are schematic diagrams of an example embodiment of a compact acoustic fire suppression system 700 having a nested acoustic wave guide 750 coupled to an acoustic wave generator 710. The acoustic wave generator 710 can be substantially the same as, if not identical to, any of the acoustic wave generator shown and described in connection with any of FIGS. 1A-6E. Accordingly, the description of the acoustic wave generator 710 is omitted herein for the purpose of brevity. As described in the illustrated embodiment, the nested acoustic wave guide 750 has an effective length of a quarter wavelength acoustic resonator within a nested structure having a shorter cross-sectional length.

Referring to FIG. 7C-7F, the nested acoustic wave guide 750 can include multiple annular wave guide segments 705a, 705b, 705c, 705d, (collectively 705) that are nested coaxially around a cylindrical wave guide segment 707. The annular wave guide segments 705 and the cylindrical wave guide segment 707 can be interconnected to define a continuous folded path. The wave guide segments 705, 707 can be interconnected by intermediate wave guide segments 709a, 709b, 709c and 709d (collectively 709) such that each of the annular wave guide segments 705 folds into an adjacent wave guide segment, thereby forming the continuous folded path. The continuous folded path can be characterized as having a serpentine shape.

As shown in FIGS. 7E and 7F, the continuous folded path of the nested acoustic wave guide 750 starts from the proximal end of a first annular wave guide segment 705a (i.e., the outermost wave guide segment closest to the piston), extending through each of the inner annular wave guide segments 705b, 705c, 705d, and terminating at the acoustic wave emitter 755 located at the distal end of the linear wave guide segment 707. For example, as shown in the illustrated embodiment, the first annular wave guide segment 705a extends from a proximal end to a distal end of the nested wave guide 750, connecting with a second annular wave guide segment 705b through a first intermediate wave guide segment 709a at the distal end of the nested wave guide. The second annular wave guide segment 705b extends from the distal end to the proximal end of the nested wave guide 750, connecting with a third annular wave guide segment 705b through a second intermediate wave guide segment 709b at the proximal end of the nested wave guide. The third annular wave guide segment 705c extends from the proximal end to the distal end of the nested wave guide 750, connecting with a fourth annular wave guide segment 705d through a third intermediate wave guide segment 709c at the distal end of the nested wave guide. The fourth annular wave guide segment 705d extends from the distal end to the proximal end of the nested wave guide 750, connecting with a cylindrical wave guide segment 707 through a fourth intermediate wave guide segment 709d at the proximal end of the nested wave guide. The cylindrical wave guide segment 707 extends from the proximal end to the distal end of the nested wave guide 750. Each of the intermediate wave guide segments 709 can be configured as a semi-circular or arc-shaped bend or fold connecting a pair of adjacent wave guide segments.

In some embodiments, the total length of the continuous folded path can be approximately equal (within +/−5%) to a one quarter wavelength, or multiple thereof, of a target resonant frequency at standard temperature and pressure. The length of each of the nested wave guide segment 705, 707 generally depends on the total number of nested waveguide segments 705, 707. For purposes of example, where the nested acoustic wave guide 750 is configured as a one quarter (¼) wavelength resonator having a resonant frequency at 20 Hz, the total length of the continuous folded path is about 14 feet (4.27 meters). Thus, in the illustrated embodiment of the nested acoustic wave guide 750 which has five (5) wave guide segments, the length of each wave guide segment is approximately equal (within +/−5%) to 2.80 feet (0.85 meters). As a result, the nested acoustic wave guide 750 can be configured as a quarter wavelength resonator with a cross-sectional length of the nested acoustic wave guide being shorter than the total length of the continuous folded path.

Although the illustrated embodiment shows a nested acoustic wave guide 750 having five (5) wave guide segments, persons skilled in the art will recognize that the cross-sectional length of the nested acoustic wave guide can be further shortened by increasing the number of annular wave guide segments. Conversely, the cross-sectional length of the nested acoustic wave guide can be lengthened by decreasing the number of annular wave guide segments. Accordingly, the total number of wave guide segments will depend on the length of the individual wave guide segments 705, 707 with respect to the total length of the continuous folded path required to configure the nested acoustic wave guide 750 as a quarter wave guide resonator.

In operation, a standing wave is created within the nested wave guide 750 in response to forward and reverse piston strokes that respectively compress and expand air within the nested wave guide segments 705, 707. Thus, with reference to FIGS. 7C-7F, on a forward stroke of the piston, the acoustic wave propagates in a forward direction from the outermost annular wave guide segment 705a to the cylindrical wave guide segment 707 at the center of the nested wave guide via the inner annular wave guide segments 705b, 705c, 705d. Conversely, on a reverse stroke of the piston, an acoustic wave propagates in a reverse direction from the cylindrical wave guide segment 707 to the outermost annular wave guide segment 705a via each of the inner annular wave guide segments 705b, 705c, 705d.

Although each of the annular wave guide segments shown in FIGS. 7B and 7C appear to have the same cross-sectional area, the annular wave guide segments 705 can have a cross-sectional area that expands along the effective length of the acoustic wave guide 750 until reaching the acoustic wave emitter 755 located at the distal end of the cylindrical wave guide segment 707. The acoustic wave emitter 755 preferably has a smaller cross-sectional area than the cross-sectional area of the linear wave guide segment 307, thereby causing a flow restriction in the emission of acoustic waves. For example, the acoustic wave emitter 755 may have a circular shape having a diameter equal to about one-half the diameter of the linear wave guide segment 707. The flow restriction at the acoustic wave emitter 755 can form a vortex that creates columnated acoustic waves for improved targeting towards a fire.

As discussed above in connection with FIG. 4, the acoustic wave generator 710 can create a standing wave within the nested acoustic wave guide 750, which results in the transmission or propagation of acoustic waves from the emitter 755 at frequencies and intensity sufficient to suppress at varying distances. Acoustic waves emitted at low frequencies between 5 Hz and 80 Hz, and preferably between 10 Hz to 25 Hz, are generally sufficient to suppress a fire. The distance at which embodiments of the compact acoustic fire suppression system 700 can effectively suppress a fire depends at least on the intensity or sound pressure level of the acoustic waves transmitted from the acoustic wave emitter 755.

Embodiments of the acoustic fire suppression system discussed above in connection with FIGS. 1A-7F can be employed for combating wildfires as well as fires in various other settings, including but not limited to residential, commercial, and industrial environments. For example, in residential settings, embodiments of the acoustic fire suppression system can be installed in attics or closets, with acoustic wave emitters of the acoustic wave guide (e.g., a hose or duct system) strategically placed to protect areas prone to wildfire embers, such as attic vents, under decks, and/or other structures or vegetation within the 0-5-foot zone surrounding the house. This proactive approach can safeguard vulnerable vegetation and mitigates the risk of fire spread.

In commercial and industrial usage, embodiments of the acoustic fire suppression system discussed above in connection with FIGS. 1A-7F can also be employed to protect high-value assets and water-intolerant equipment in commercial and industrial facilities. Emitters of the acoustic fire suppression system can be positioned to safeguard critical infrastructure, such as machining equipment and data centers, minimizing downtime and loss of productivity. Electrical fire suppression: ducts routed to electrical panels enable the acoustic fire suppression device to detect and suppress electrical fires at their source, preventing potential damage to electrical systems and averting catastrophic fire events.

FIGS. 8A and 8B are schematic diagrams that illustrate example embodiments of acoustic fire suppression systems configured for suppressing fires inside or outside a building. A building can be any residential, industrial, or commercial facility, including any without limitation homes, garages, warehouses, aircraft hangers, recycling facilities, manufacturing facilities, and shipping facilities.

In the illustrated embodiment of FIG. 8A, the acoustic fire suppression system 100′ of FIG. 1B is shown deployed inside of a building 800 for suppressing fires. As previously discussed in connection with FIG. 1B, the acoustic wave generator 110′ is coupled to the acoustic wave guide 150′, which is configured as a network of interconnected duct segments, collectively 152′. The network of duct segments 152′ defines multiple paths away from the acoustic wave generator 110′ to multiple acoustic wave emitters 155′ distributed along the various segments. In this example, the network of interconnected duct segments includes a main duct segment and six secondary duct segments that branch away from the main duct segment, thereby defining multiples paths away from the acoustic wave generator 110′.

As discussed above in connection with FIGS. 4 and 5, each fixed length path of the acoustic wave guide 150′ can be operated as a fixed length quarter wavelength acoustic resonator under the control of a control module 420. For example, when a frequency of the acoustic waves generated by the acoustic wave generator 110′ matches a target resonant frequency of the acoustic wave guide 150′, a standing wave forms for efficient emission of the acoustic waves through one or more selectively opened acoustic wave emitters 155′. Each emitter is preferably located at or near an atmospheric pressure node of the standing wave for efficient emission of the acoustic waves.

As discussed above in connection with FIG. 5, the lengths of the available paths through the network of duct segments 152′ to the respective emitters 155′ can differ. Thus, in some embodiments, to efficiently emit acoustic wave through one or more selectively opened emitters 155′, the control module (e.g. 420) can determine the target resonant frequency and thus the operating frequency at which to drive the piston (e.g., 435) based at least in part on the speed of sound in air under current ambient conditions and the length of a path that extends from the proximal end of the main duct segment (e.g., 152′a) to the location of one of the selectively opened emitter(s) of any one of the duct segments (e.g., 152′a through 152′g).

As shown in the illustrated embodiment, the acoustic wave guide 150′ can be attached to a ceiling of the building 800 with the acoustic wave emitters 155′ directed downward or at an angle toward a space to be protected. Additionally, or alternatively, the acoustic wave guide 150′ can be attached to one or more walls or other fixed support structures within the building 800. In some embodiments, the acoustic fire protection system 100′ can be used as a replacement to conventional sprinkler heads. With respect to residential homes, the acoustic wave generator 110′ can be located within a closet, attic, garage, or other suitable location and the acoustic wave guide 150′ can be routed therefrom to the attic, garage, along gutters, under decks, within vegetation around the home, and other confined spaces inside and outside the home that need to be protected.

In FIG. 8B, one or more compact acoustic fire suppression systems 700 can be deployed at various locations inside a building 800 for suppressing fires. As previously discussed in connection with FIGS. 7A-7F, the compact acoustic fire suppression system 700 can have a nested acoustic wave guide 750 that is coupled to an acoustic wave generator 710. The nested acoustic wave guide 750 can have an effective length of a quarter wavelength acoustic resonator within a nested structure having a shorter cross-sectional length for compactness.

As shown in the illustrated embodiment, each compact acoustic fire suppression system 700 can be attached to a ceiling of the building 800 with the acoustic wave emitter 755 of the nested acoustic wave guide directed downward or at an angle toward a space inside the building 800. Additionally or alternatively, the acoustic fire suppression system 700 can be attached to one or more walls or other fixed support structures inside the building 800. In some embodiments, each of the acoustic fire suppression systems 700 can be operated by a respective control module (e.g., 420) as shown and described in connection with FIGS. 4 and 5. Alternatively or additionally, in some embodiments, the acoustic fire suppression system 700 can be collectively controlled by one control module (e.g., 420).

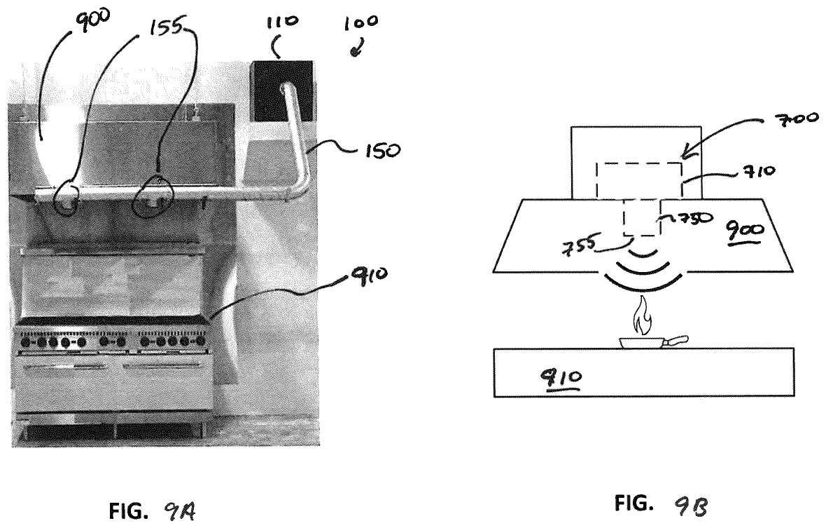

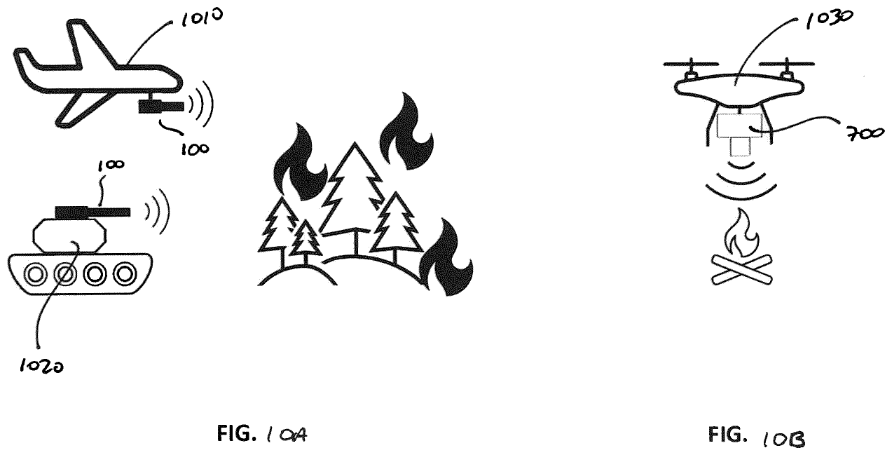

FIGS. 9A and 9B are schematic diagrams that illustrate example embodiments of acoustic fire suppression systems configured for suppressing fires in a kitchen or other cooking facility.

In the illustrated embodiment of FIG. 9A, the acoustic fire suppression system 100 of FIG. 1A affixed to a kitchen hood 900 to suppress a fire from above a stove 910, e.g., a grease fire. As discussed in connection with FIG. 1A, the acoustic fire suppression system 100 can include an acoustic wave guide 150 that extends away from the acoustic wave generator 110 along a path that includes one or more bends or turns. In FIG. 9A, the acoustic wave guide 150 extends away from the acoustic wave generator 110 along a path that bends along a front portion of the kitchen hood 900. Further, as shown, the acoustic wave guide 150 also includes two acoustic wave emitters 155 directed downward or at an angle towards the stove 910. As discussed above in connection with FIGS. 3A-3C, each acoustic wave emitter 155 can be located along the acoustic wave guide 150 at a location near the expected locations of one or more atmosphere pressure nodes (e.g., at a space of about +/−5% of the spacing of a quarter wavelength, or multiple thereof).

As discussed above in connection with FIG. 4, one or more of the acoustic wave emitters 155 can be selectively opened in response to a fire detected on the stove 910 by a flame sensor (not shown) distributed on the kitchen hood 900, the stove 910, and/or along the acoustic wave guide 150 itself. Further, as discussed in connection with FIG. 5, the acoustic generator 110 can control the emission of the acoustic waves at a target resonant frequency of the acoustic wave guide 150 through one or more selectively activated acoustic wave emitters 155 for suppressing a kitchen fire.

In FIG. 9B, a compact acoustic fire suppression system 700 having a nested acoustic wave guide 750 can be affixed to the kitchen hood 900 to suppress fires on the stove 910. As previously discussed in connection with FIGS. 7A-7F, the nested acoustic wave guide 750, which is mounted to an acoustic wave generator 710, can have an effective length of a quarter wavelength acoustic resonator within a nested structure having a shorter cross-sectional length for compactness. Thus, as shown in the illustrated embodiment, the acoustic fire suppression system 700 can be disposed on the inside of the kitchen hood 900, such that the acoustic wave emitter 755 of the nested acoustic wave guide 750 is directed downward facing a stove 910. Alternatively or additionally, in some embodiments, the acoustic fire suppression system 700 can be affixed to any external portion of the kitchen hood 900 with the acoustic wave emitter 755 directed toward a cooking area of the stove 910.

As discussed above in connection with FIG. 4, the acoustic wave emitter 755 can be selectively opened in response to a fire detected on the stove 910 by a flame sensor (not shown) distributed on the kitchen hood 900, the stove 910, and/or adjacent to the emitter 755 itself. Further, as discussed in connection with FIG. 5, the acoustic generator 710 can control the emission of emit acoustic waves at a target resonant frequency of the acoustic wave guide 750 through the acoustic wave emitter 755 for suppressing a kitchen fire.

FIGS. 10A and 10B are schematic diagrams that illustrate example embodiments of acoustic fire suppression systems mounted to any vehicle capable of transporting the acoustic fire suppression system to the location of, or in the vicinity of, an outdoor fire. Examples of an outdoor fire can include, without limitation, wildfires or incipient fires similar to a Class 1A or 1B size (e.g., unattended campfires). Such vehicles may also be useful in navigating an acoustic fire suppression system within building to suppress indoor fires.

In FIG. 10A, the acoustic fire suppression system 100 of FIG. 1 is shown mounted to an aerial vehicle 1010 and a ground vehicle 1020, respectively, for transport to the location or vicinity of any indoor or outdoor fire, including wildfires. Examples of aerial vehicles 1010 can include, without limitation, aircraft, aerial drones, balloons, and other types of vehicles capable of traveling above ground through the air, both manned and unmanned. Examples of ground vehicles 1020 can include, without limitation, tanks, cranes, cars, trucks, all-terrain vehicles (ATVs), ground-based drones, robotic dogs, tracked robotic vehicles, and other vehicles capable of traveling on land, both manned and unmanned ground vehicles.

However, in some embodiments, the acoustic fire suppression system 100 may be impractical for some applications having limited length, size, and/or weight requirements. Accordingly, as shown in the illustrated embodiment of FIG. 10B, the compact acoustic fire suppression system 700 of FIG. 7A-7F can be mounted to an aerial vehicle or a ground vehicle, whether manned or unmanned, for transporting the acoustic fire suppression system 700 to the location of, or in the vicinity of, an indoor or outdoor fire. As previously discussed, the compact acoustic fire suppression system 700 has a nested acoustic wave guide 750 for a reduced cross-sectional length.

As shown, FIG. 10B illustrates the compact acoustic fire suppression system 700 being mounted to an aerial drone 1030 for transport to the location or vicinity of a small or minor incipient fire (e.g., unattended campfires) in an outdoor woodland or wildland setting. In some embodiments, the compact acoustic fire suppression system 700 can be configured to emit acoustic waves to suppress a Class A fire at least 60 centimeters in diameter from a minimum distance of at least 10 meters. Preferably, the Class A fire can be suppressed within 5 minutes or battery life of the compact acoustic fire suppression system 700. A Class A fire can be defined by ISO Standard No. ISO/TC 21/SC 1. In some embodiments, the compact acoustic fire suppression system 700 can have a total weight that is less than 6 kilograms. In some embodiments, the compact acoustic fire suppression system 700 can have a horizontal footprint of or about 50 centimeters in diameter and a vertical height of or about 40 centimeters. In some embodiments, the compact acoustic fire suppression system 700 can withstand a minimum of one hour of continuous operation prior to maintenance or servicing being required.

In some embodiments, various components of the acoustic fire suppression system 100 of FIG. 10A or the compact acoustic fire suppression system 700 of FIG. 10B can be constructed using composites, such as but not limited to carbon fiber composites. Carbon fiber composites are generally lightweight materials with exceptional strength-to-weight ratio and stiffness, making them suitable for use in connection with aerial vehicles. Furthermore, carbon fire composites generally exhibit good fire resistance properties, making them suitable for use in high-temperature environments. Composites, such as carbon fiber composites, may also be used to construct various components of the acoustic fire suppression system 100 of FIG. 10A or the compact acoustic fire suppression system 700 in other non-aerial applications, such as those described herein.

In some embodiments, the acoustic fire suppression system 100 of FIG. 10A or the compact acoustic fire suppression system 700 can be attached to an aerial vehicle or a ground vehicle on a gimbal (not shown) that permits the respective acoustic fire suppression system to be directed towards any indoor or outdoor fire at any direction and angle. The gimbal can be configured to automatically direct an emitter of a respective acoustic fire suppression system 100, 700 towards the heat or other thermal signature of a fire using flame sensors (not shown) attached to the acoustic fire suppression system or the vehicle itself.

In some embodiments, multiple aerial or ground vehicles carrying an acoustic fire suppression system (e.g., 100, 700) may be used in tandem, or swarm, to encapsulate fire and prevent spread rather than attempting to directly suppress the fire (e.g., alongside prescribed burns for containment purposes).

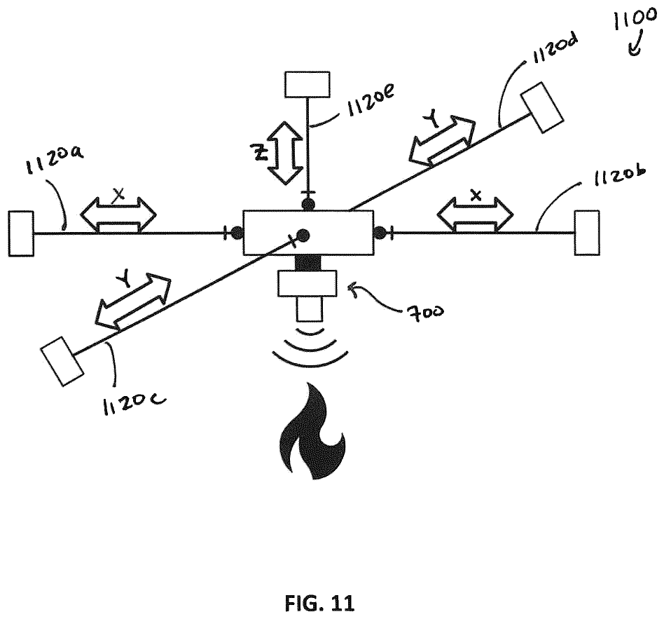

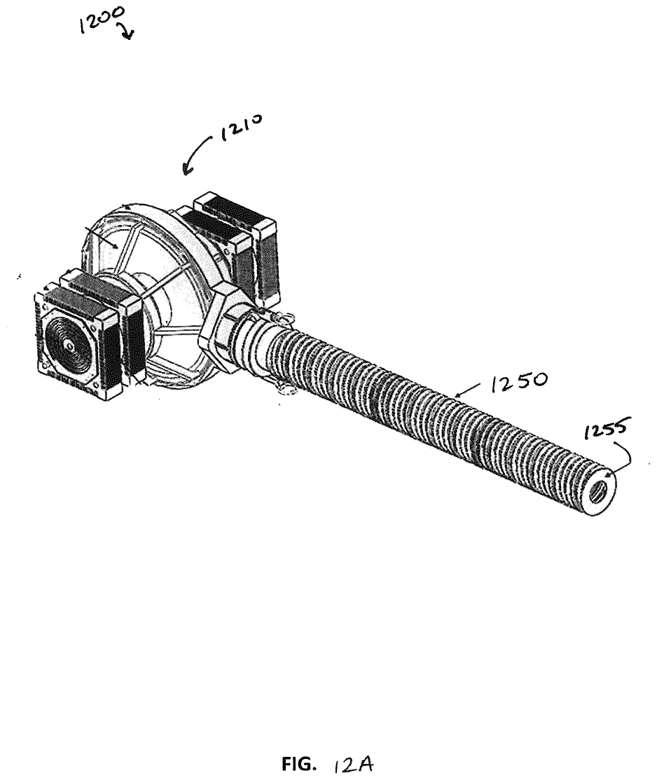

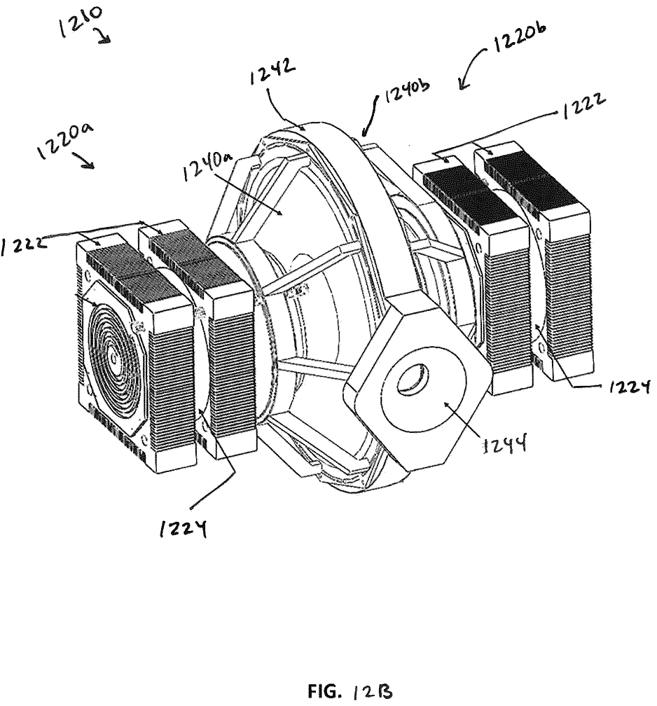

FIG. 11 is a schematic diagram that illustrate an example embodiment of a compact acoustic fire suppression system (e.g., 700) mounted to on an aerial wire transport system. As shown, the compact acoustic fire suppression system 700 shown and described in connection with FIGS. 7A-7F can be suspended from the aerial wire transport system 1100. The aerial wire transport system can be a computer-controlled cable-drive system for maneuvering the acoustic fire suppression system 700 in two or three dimensions in an open space above an area to be protected.

In the illustrated embodiment, the aerial wire transport system 1100 includes a transport platform 1110 to which the compact acoustic fire suppression system 700 is attached. The transport platform 1110 can be movably coupled to a plurality of wires 1120a, 1120b, 1120c, 1120d, 1120e (collectively or individually 1120) that extend from a winch and pulley system (not shown). Depending on the direction in which the winch and pulley system reels the respective wires 1120, the transport platform 1110, and thus the compact acoustic fire suppression system 700 attached thereto, can move in any direction along the X, Y, and/or Z axis. In some embodiments, the winch and pulley system (not shown) can be controlled by a fire detection system (not shown) to move the transport platform 1110, and thus the compact acoustic fire suppression system 700, to a location of a fire within the area covered by the aerial wire transport system 1100. Once the compact acoustic fire suppression system 700 reaches the location of the fire, the compact acoustic fire suppression system 700 can emit acoustic waves for suppressing a fire as discussed above in connection with FIGS. 4-7F.

In another example, one or more of the acoustic fire suppression systems described above (e.g., 100, 100′, 200, 700) can be operated in a phased or other marine vehicle setting as a replacement to conventional suppression systems, as a preventive, proactive or responsive method in maritime transportation for oil, gas, liquified fuel, and electric vehicle, as well as for marine engine compartments, personnel quarters, and cabins.

In another example, one or more of the acoustic fire suppression systems described above (e.g., 100, 100′, 200, 700) can be operated in a phased or other microgravity setting as a replacement to conventional fire suppression systems applied to microgravity manufacturing, space station, lunar or planetary habitats, and other spacecraft applications.

In another example, one or more of the acoustic fire suppression systems described above (e.g., 100, 100′, 200, 700) can be operated in a phased or other structural setting as a replacement to conventional sprinkler or chemical systems, protecting areas of battery installation, battery storage, and the areas contiguous to same.

As previously discussed in connection with FIG. 6A-6E, the intensity or sound pressure level of the acoustic waves generated by an acoustic wave generator depends at least in part the stroke length at which a piston (e.g., 610) is driven. However, in some embodiments, the intensity of the acoustic waves can be further increased by employing more than one piston.

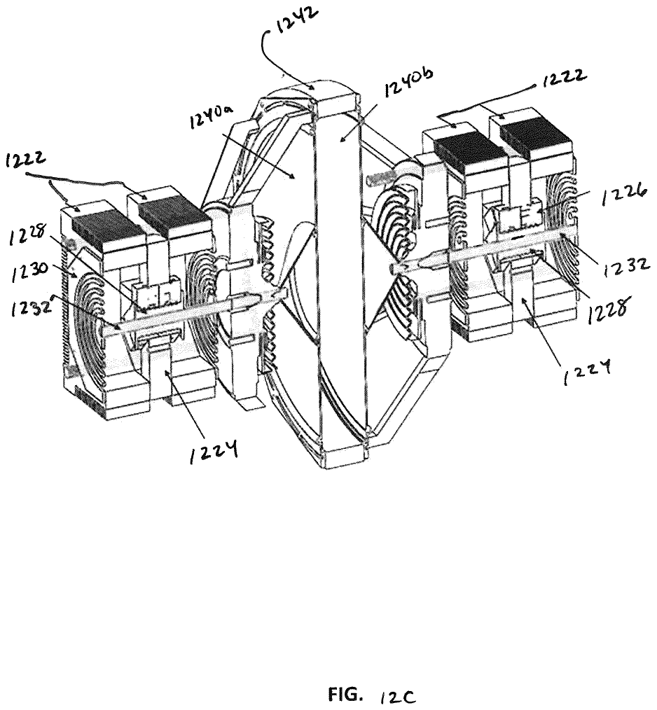

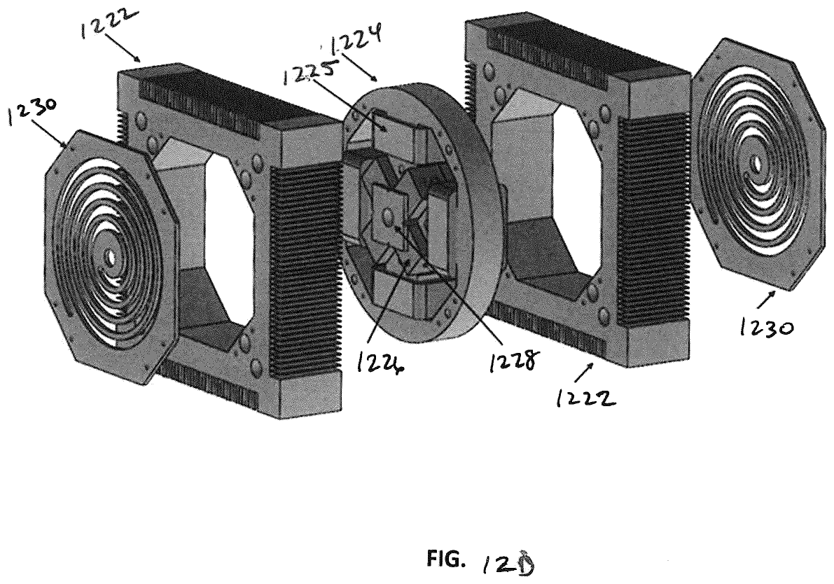

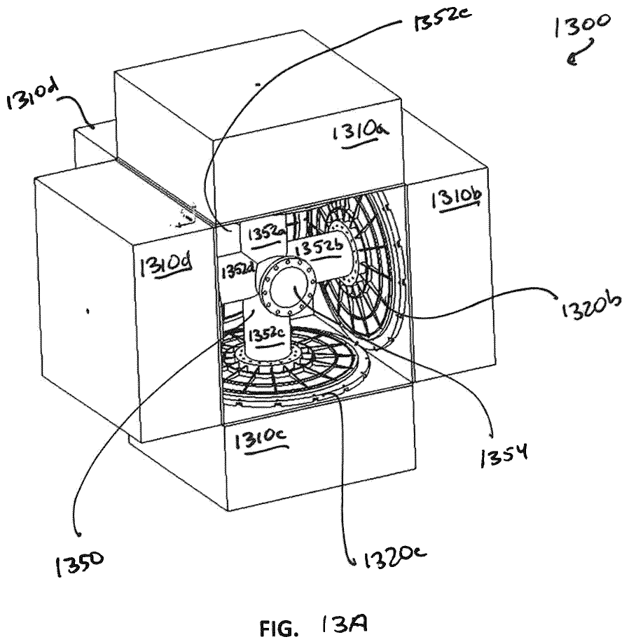

FIG. 12A-12D are schematic diagrams of an example embodiment of an acoustic fire suppression system 1200 that includes an acoustic wave generator 1210 having more than one piston for increasing the intensity of the acoustic waves emitted from the acoustic wave guide 1250. As shown in FIG. 12A, the acoustic wave generator 1210 is coupled to an acoustic wave guide 1250. In some embodiments, the acoustic wave guide 1250 can have structure that is substantially the same, if not identical to, the structure of any of the acoustic wave guides 150, 150a, and 750 shown and described in connection with FIGS. 1, 2, and 7A-7E. Accordingly, the structure of the acoustic wave guide 1250 is omitted for brevity.

Referring to FIGS. 12B and 12C, the acoustic wave generator 1210 can include two linear motion actuators 1220a, 1220b (collectively or individually 1220), each linear motion actuator driving a respective piston 1240a, 1240b (collectively or individually 1240). The pistons 1230 are coupled to opposite sides of a common pressure chamber 1242. The common pressure chamber 1242 is generally a sealed volume having an outlet 1244 through which the acoustic wave is transmitted to the acoustic wave guide 1250.

As described above in connection with FIGS. 4 and 5, a control module (e.g., 420) can control each of the linear motion actuators 1220 to drive the respective pistons 1240 at a target resonant frequency and intensity. In the illustrated embodiment, the control module (e.g., 420 of FIG. 4) synchronizes the back-and-forth motion of the pistons 1240 to compress and expand the volume of air within the common pressure chamber 1242. This synchronized compression and expansion of air creates a corresponding pressure increase and decrease within the common pressure chamber 1242. As the pressure increases and decreases in the pressure chamber 1242, air particles in the attached acoustic wave guide 1250 are vibrated, thereby transmitting an acoustic wave towards one or more of the acoustic wave emitters 1255 of the acoustic wave guide. By compressing and expanding the air within the common pressure chamber 1242 using at least two pistons 1240, the intensity at which the acoustic waves are emitted from the acoustic wave emitter(s) 1255 can be greater than the intensity of the acoustic waves generated by a single piston.

Referring to FIGS. 12C and 12D, each of the linear motion actuators 1220 can include a frame 1222, a stator 1224, wire coils 1225, magnets 1226, a magnet retainer 1228, flexures 1230, and a piston rod 1232 coupled to one of the pistons 1240. In some embodiments, the frame 1222, the stator 1224, the magnets 1226, the magnet retainer 1228, the flexures 1230, and the piston rod 1232 of each linear motion actuator 1220 can have structure that is substantially the same, if not identical to, the structure of the frame 640, the stator 650, the wire coils 657, the magnets 660, the magnet retainer 670, the flexures 680, and the piston rod 630 of the linear motion actuator 600 shown and described in connection with FIGS. 6A-6E. Accordingly, details regarding the structure and function of the linear motion actuators 1220 is omitted for brevity.

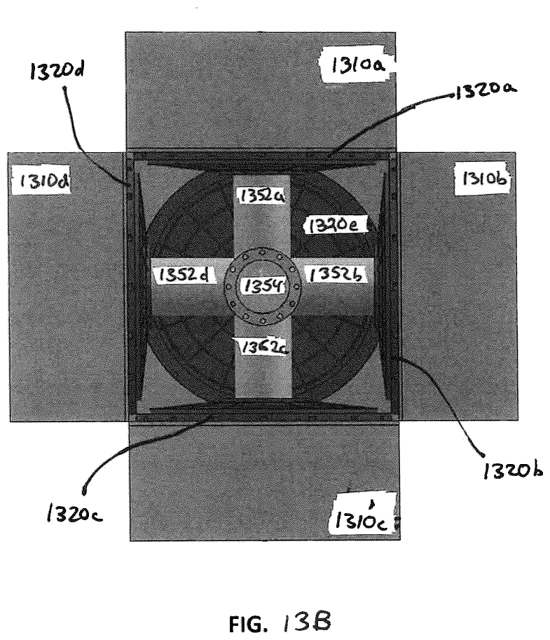

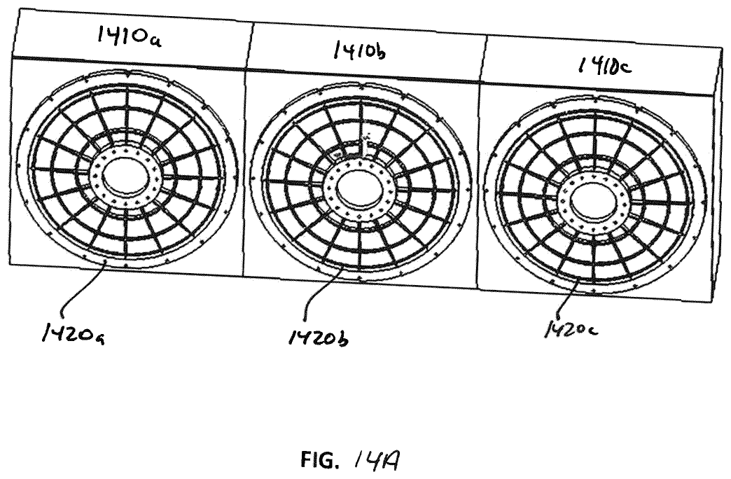

FIGS. 13A and 13B are schematic diagrams illustrating an example embodiment of an acoustic fire suppression system 1300 including a modular arrangement of multiple acoustic wave generators 1310a, 1310b, 1310c, 1310d, 1310e (individually and collectively 1310) that are coupled to an acoustic wave combiner 1350 having multiple acoustic wave guide inlet segments 1352a, 1352b, 1352c, 1352d, 1352e (collectively or individually 1352) and a single acoustic wave outlet segment 1354. Although omitted for purposes of clarity, the acoustic wave outlet segment 1354 can be coupled to any of the acoustic wave guides 150, 150′, 250, and 750 shown and described above in connection with FIGS. 1A, 1B, 2, and 7A-7F.

Each of the acoustic wave generators 1310 drives a respective piston 1320a, 1320b, 1320c, 1320d, 1320e (collectively or individually 1320) to generate an acoustic wave that enters a respective one of the acoustic wave guide inlet segments 1352. The acoustic wave generators 1310 can be substantially the same as, if not identical to, any of the acoustic wave generators shown and described in connection with any of FIGS. 1A-6E. Accordingly, the description of the acoustic wave generators 1310 is omitted herein for the purpose of brevity.

After entering the acoustic wave combiner 1350, the acoustic waves produced by the acoustic wave generators 1310 converge at the acoustic wave guide outlet segment 1354 to produce a resultant acoustic wave. By controlling the acoustic wave generators 1310 such that the back-and-forth motion of the pistons 1320 are synchronized, the acoustic waves entering the inlet segments 1352 can converge at the outlet segment 1354 in phase, thereby forming the resultant acoustic wave with greater intensity or sound pressure level for suppressing large fires or fires located at greater distances away. In the illustrated embodiment, the acoustic fire suppression system 1300 includes five (5) acoustic wave generators 1310 are connected to the acoustic wave combiner 1350. However, more or less than five acoustic wave generators 1310 can be connected to the acoustic wave combiner 1350.

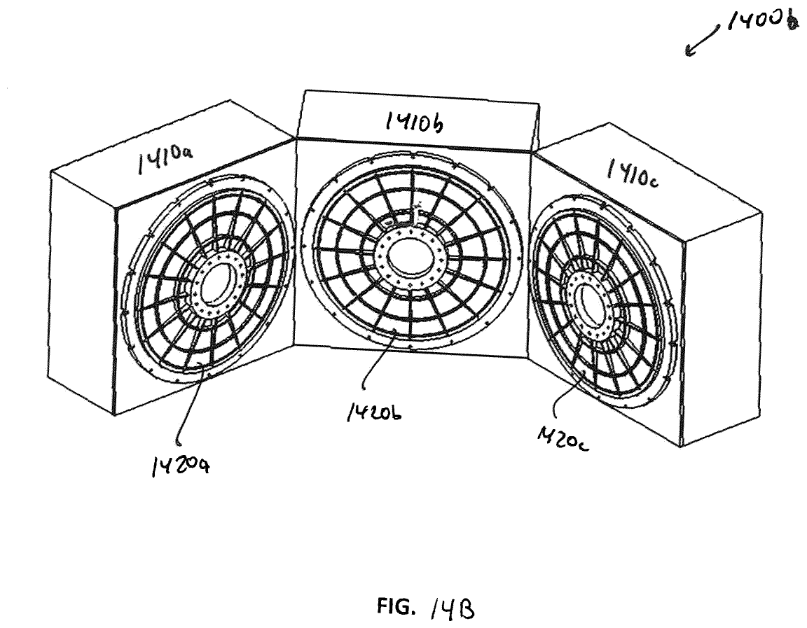

FIGS. 14A and 14B are schematic diagrams illustrating an acoustic fire suppression system that includes multiple acoustic wave generators 1410a, 1410b, and 1410c (collectively or individually 1410) arranged in different layouts for increasing the intensity of acoustic waves. Although omitted for purposes of clarity, each of the acoustic wave generators 1410 can be coupled to any of the acoustic wave guides 150, 250, and 750 shown and described in connection with FIGS. 1A, 2, and 7A-7E.

In the illustrated embodiment of FIG. 14A, the acoustic fire suppression system 1400a arranges the acoustic wave generators 1410 as a linear array. Although the acoustic wave generators 1410 are arranged as a linear array in a horizontal direction, the acoustic wave generators can be arranged next to one another in any linear direction (e.g., vertical direction). In other embodiments, multiple linear arrays of the acoustic wave generators 1410 can be arranged to form in an N×M planar array, where each of N and M represent at least two or more acoustic wave generators 1410.

In operation, a control module (e.g., 420 of FIG. 4) can synchronize the acoustic wave output of the acoustic wave generators 1310 such that the acoustic waves emitted from the respective acoustic wave guides (not shown) overlap in-phase to form larger acoustic waves with increased intensity (or sound pressure level) as they propagate through the air. In other words, the crests and troughs of the acoustic waves emitted from the respective acoustic wave guides (not shown) coincide, creating an amplified wavefront that can travel greater distances without dissipating.

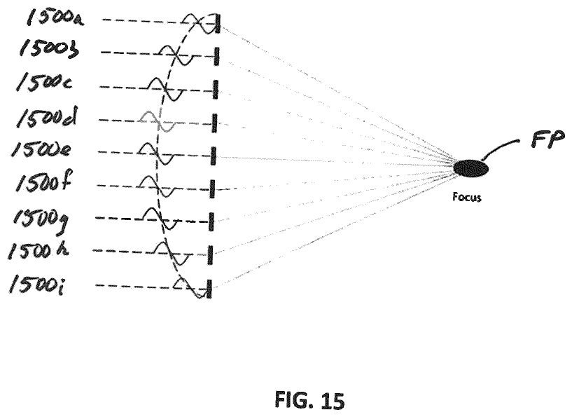

In the illustrated embodiment of FIG. 14B, the acoustic wave generators 1410a, 1410b, and 1410c (collectively or individually 1410) are arranged as a phased array. Each of the acoustic wave generators 1410 drives a respective piston 1420a, 1420b, 1420c, 1420d, 1420e (collectively or individually 1420) to generate an acoustic wave at a target frequency and intensity. Although omitted for purposes of clarity, each of the acoustic wave generators 1410 can be coupled to any of the acoustic wave guides 150, 250, and 750 shown and described in connection with FIGS. 1A, 2, and 7A-7E. The phased array of acoustic wave generators 1410 can have a parabolic shape, such that the emitters of the respective acoustic wave guides (not shown) are aimed towards a common focus point (e.g., FP of FIG. 15). The focus point can be a distant target corresponding to the location of a fire or an area being protected by acoustic fire suppression system 1400. In operation, a control module (e.g., 420 of FIG. 4) can shift the phase of each of the acoustic waves generated by the acoustic wave generators 1410 such that the acoustic waves emitted from the respective acoustic wave guides (not shown) overlap in-phase at or near the common focus point, thereby forming larger acoustic waves with increased intensity (or sound pressure level).

FIG. 15 is an example timing diagram illustrating nine (9) acoustic fire suppression systems collectively 1500a to 1500i (collectively 1500), emitting acoustic waves at different times such that the individual waves converge in phase at the focus point FP (e.g., location of fire). In some embodiments, the acoustic fire suppression systems can have substantially the same, if not identical, structure as the acoustic fire suppression systems 1400 and 1400a as described above in connection with FIGS. 14A and 14B, respectively.

In the illustrated timing diagram, the acoustic fire suppression systems (e.g., 1500a, 1500i) located at the outer perimeter of the linear or phased array have a longer distance to travel than the acoustic fire suppression systems located at (e.g., acoustic fire suppression system 1500e) or adjacent to the center (e.g., acoustic fire suppression system 1500d, 1500f) of the linear or phased array. Accordingly, a control module (e.g., 420) of the respective acoustic fire suppression systems 1500 can be synchronized such that the emission of acoustic waves from the acoustic cannons are increasingly delayed for the acoustic fire suppression systems disposed at or in close proximity the center of the array as compared to the acoustic fire suppression systems disclosed towards the outer perimeter of the array. With this method, a larger acoustic energy can be transmitted through the ambient air than any single acoustic cannon could produce on its own.

It should be understood that the example embodiments described above may be implemented in many different ways. Embodiments may therefore typically be implemented in hardware, custom designed semiconductor logic, Application Specific Integrated Circuits (ASICs), Field Programmable Gate Arrays (FPGAs), firmware, software, or any combination thereof.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Therefore, while this invention has been particularly shown and described with references to example embodiments thereof, it will be understood by those skilled in the art that various changes in form and details may be made therein without departing from the scope of the invention as encompassed by the appended claims.

What is claimed is:

1. A method of control an acoustic fire suppression system, wherein the acoustic fire suppression system comprises an acoustic wave generator coupled to an acoustic wave guide, the method comprising:
selectively opening one or more of a plurality of acoustic wave emitters distributed along the acoustic wave guide for emitting acoustic waves into the atmosphere towards a fire;
determining a resonant frequency of the acoustic wave guide based on a location of a selected acoustic wave emitter among the one or more acoustic wave emitters; and
controlling the acoustic wave generator to generate the acoustic waves that are emitted through the one or more acoustic wave emitters at the resonant frequency of the acoustic wave guide determined based on the location of the selected acoustic wave emitter.

2. The method of claim 1, wherein determining the resonant frequency of the acoustic wave guide that is associated with the selected acoustic wave emitter comprises:
determining a length of a path through the acoustic wave guide from the acoustic wave generator to the location of the selected acoustic wave emitter;
determining a speed of sound under ambient conditions surrounding the acoustic wave guide, the ambient conditions including at least ambient temperature; and
determining the resonant frequency of the acoustic wave guide based on the length of the path through the acoustic wave guide to the location of the selected acoustic wave emitter and the speed of sound under the ambient conditions surrounding the acoustic wave guide.

3. The method of claim 1, wherein the acoustic wave guide comprises a plurality of interconnected duct segments, the plurality of acoustic wave emitters being distributed along the plurality of interconnected duct segments, such that one or more of the plurality of interconnected duct segments define the path to the location of the selected acoustic wave emitter, and
wherein the resonant frequency of the acoustic wave guide is determined based on a length of the path through the one or more interconnected duct segments to the location of the selected acoustic wave emitter.

4. The method of claim 3, wherein the plurality of interconnected duct segments of the acoustic wave guide includes a first duct segment that extends away from the acoustic wave generator and one or more second duct segments that branch away from the first duct segment, and
wherein the resonant frequency of the acoustic wave guide is determined based on a length of the path from a proximal end of the first duct segment to the selected acoustic wave emitter located at any of the first duct segment and the one or more second duct segments.

5. The method of claim 1, wherein the plurality of acoustic wave emitters are spaced apart at or near locations along the acoustic wave guide that correspond to expected locations of atmospheric pressure nodes of a standing wave that forms within the acoustic wave guide in response to the acoustic waves being generated at the resonant frequency of the acoustic wave guide.

6. The method of claim 1, wherein the acoustic wave guide is operated as a quarter wavelength acoustic resonator.

7. The method of claim 1, wherein the resonant frequency of the acoustic wave guide for the selected acoustic wave emitter is a frequency within an inclusive range of 10 Hertz to 80 Hertz.

8. The method of claim 1, wherein the acoustic wave generator drives a piston to generate the acoustic waves at the resonant frequency of the acoustic wave guide associated with the selected acoustic wave emitter.

9. The method of claim 8, further comprising adjusting an operating frequency of the piston to match the resonant frequency of the acoustic wave guide in response to changes in the ambient conditions surrounding the acoustic wave guide.

10. The method of claim 1, wherein the one or more acoustic wave emitters are selectively opened among the plurality of acoustic wave emitters based on a proximity of the one or more acoustic wave emitters to the fire.

11. An acoustic fire suppression system, comprising:
an acoustic wave guide having a plurality of acoustic wave emitters;
an acoustic wave generator coupled to the acoustic wave guide; and
a command module that selectively opens one or more of the plurality of acoustic wave emitters for emitting acoustic waves into the atmosphere towards a fire;
the command module determining a resonant frequency of the acoustic wave guide based on a location of a selected acoustic wave emitter among the one or more acoustic wave emitters; and
the command module controlling the acoustic wave generator to generate the acoustic waves that are emitted through the one or more acoustic wave emitters at the resonant frequency of the acoustic wave guide determined based on the location of the selected acoustic wave emitter.

12. The acoustic fire suppression system of claim 11, wherein to determine the resonant frequency of the acoustic wave guide that is associated with the selected acoustic wave emitter, the control module is configured to:
determine a length of a path through the acoustic wave guide from the acoustic wave generator to the location of the selected acoustic wave emitter;
determine a speed of sound under ambient conditions surrounding the acoustic wave guide, the ambient conditions including at least ambient temperature; and
determine the resonant frequency of the acoustic wave guide based on the length of the path through the acoustic wave guide to the location of the selected acoustic wave emitter and the speed of sound under the ambient conditions surrounding the acoustic wave guide.

13. The acoustic fire suppression system of claim 11, wherein the acoustic wave guide comprises a plurality of interconnected duct segments, the plurality of acoustic wave emitters being distributed along the plurality of interconnected duct segments, such that one or more of the plurality of interconnected duct segments define the path to the location of the selected acoustic wave emitter, and
wherein to determine the length of the path through the acoustic wave guide to the selected acoustic wave emitter, the control module is configured to determine the length of the path through the one or more interconnected duct segments to the location of the selected acoustic wave emitter.

14. The acoustic fire suppression system of claim 13, wherein the plurality of interconnected duct segments of the acoustic wave guide includes a first duct segment that extends away from the acoustic wave generator and one or more second duct segments that branch away from the first duct segment, and
wherein to determine the length of the path through the acoustic wave guide to the selected acoustic wave emitter, the control module is configured to determine the length of the path from a proximal end of the first duct segment to the selected acoustic wave emitter located at any of the first duct segment and the one or more second duct segments of the acoustic wave guide.

15. The acoustic fire suppression system of claim 11, wherein the plurality of acoustic wave emitters are spaced apart at or near locations along the acoustic wave guide that correspond to expected locations of atmospheric pressure nodes of a standing wave that forms within the acoustic wave guide in response to the acoustic waves being generated at the resonant frequency of the acoustic wave guide.

16. The acoustic fire suppression system of claim 11, wherein the acoustic wave guide is operated as a quarter wavelength acoustic resonator.

17. The acoustic fire suppression system of claim 11, wherein the resonant frequency of the acoustic wave guide for the selected acoustic wave emitter is a frequency within an inclusive range of 10 Hertz to 80 Hertz.

18. The acoustic fire suppression system of claim 11, wherein the acoustic wave generator drives a piston to generate the acoustic waves at the resonant frequency of the acoustic wave guide associated with the selected acoustic wave emitter.

19. The method of claim 18, wherein the control module adjust an operating frequency of the piston to match the resonant frequency of the acoustic wave guide in response to changes in the ambient conditions surrounding the acoustic wave guide.

20. The acoustic fire suppression system of claim 11, wherein the one or more acoustic wave emitters are selectively opened based on a proximity of the one or more acoustic wave emitters to a detected fire.
